(19) United States
(12) Patent Application Publication
(10) Pub. No.: US 2008/0264445 A1
(43) Pub. Date: Oct. 30, 2008

(54) SYSTEM AND METHOD FOR TREATING FLOORS

(75) Inventors: Mark D. Levitt, Lake Elmo, MN (US); Minyu Li, Oakdale, MN (US); Lauren K. Carlson, St. Paul, MN (US)

Correspondence Address: ECOLAB INC., MAIL STOP ESC-F7, 655 LONE OAK DRIVE, EAGAN, MN, 55121, US

(73) Assignee: ECOLAB INC., ST. PAUL, MN (US)

(21) Appl. No.: 11/923,410

(22) Filed: Oct. 24, 2007

Related U.S. Application Data
(60) Provisional application No. 60/862,650, filed on Oct. 24, 2006.

(51) Int. Cl. B08B 7/00

(52) U.S. Cl. 134/6

(57) ABSTRACT

The invention pertains to a system and method for treating floors with an antimicrobial composition, where the floor finish applied to a floor is resistant to degradation by the antimicrobial composition and in particular quaternary ammonium compound.

### RELATED APPLICATIONS

This application claims priority to U.S. Provisional Patent Application No. 60/862,650, filed on Oct. 24, 2006. The entire contents of this patent application are hereby expressly incorporated herein by reference including, without limitation, the specification, claims and abstract, as well as any figures, tables, or drawings thereof.

### FIELD OF THE INVENTION

This disclosure pertains to a system and method for treating floors with an antimicrobial composition, where the floor finish applied to a floor is resistant to degradation by the antimicrobial composition. More specifically, this disclosure provides methods for treating floors comprising applying an antimicrobial resistant floor finish composition to a floor. A quaternary ammonium compound antimicrobial composition is then applied to the floor without substantially degrading the floor finish.

### BACKGROUND

Hospitals, nursing homes, surgical centers, veterinary facilities, dentist offices, eye care offices, clinics, daycares, long term care facilities, and other patient care locations regularly apply an antimicrobial composition to the floors in public spaces and patient rooms in order to reduce the microbial population on the floor and control the spread of microorganisms.

In fact, the use of disinfectant cleaners under certain circumstances, i.e., to clean blood or body fluid spills, is prescribed by guidelines published by the Center for Disease Control (“CDC”). See Guideline for Handwashing and Hospital Environmental Control, 1985, Julia S. Garner, Matin S. Favero; Hospital Infections Program Center for Infectious Diseases, Centers for Disease Control and Prevention.

One preferred antimicrobial composition is a quaternary ammonium based composition. Over the course of a day a floor may be mopped with a quaternary ammonium based composition 1 to 3 times. This is especially true when floors are contaminated with blood or body fluids and in instances where multi-drug resistant organisms may be present. It is preferable that the antimicrobial solution be changed at least every three rooms to avoid cross-contamination. The most common method of applying antimicrobial composition is by the use of a string mop and mop bucket. The mop head is typically composed of cotton, rayon or a blend of cotton and rayon. Flat mops composed of polyester and nylon microfiber are also increasingly coming into use.

Quaternary ammonium compounds are positively charged and have been observed to absorb or adsorb on to the surface of a textile such as a mop head. This is significant because a minimum amount of quaternary ammonium compound must be transferred to a floor in order to properly reduce the population of microorganisms on the floor. In most cases, it is required that approximately 450 to 1000 ppm of the quaternary ammonium compound must be applied to a floor surface in order to kill residual microorganisms. The exact amount of composition that must be applied to a floor is determined by the concentration of active quaternary ammonium compound in the composition and target organisms. For example, the quaternary ammonium compound level in an A456N use solution, commercially available from Ecolab Inc. (St. Paul, Minn.), is 660 ppm. Accordingly, in order to properly reduce the population of microorganisms on a floor surface when using an A456N use solution, 660 ppm of quaternary ammonium compound must be delivered to the floor surface. If a portion of the quaternary ammonium compound is absorbed or adsorbed onto a mop head, then some amount of quaternary ammonium compound less than the required concentration will be delivered to the floor surface and the microorganisms will not be sufficiently reduced. See Kimberly-Clark, On the Surface: Optimum Infection Control Practice. This increases the risk of spreading microorganisms in locations where people are particularly sensitive to infection such as hospitals, surgical centers, nursing homes, and the like.

The absorption or adsorption of antimicrobial compounds such as quaternary ammonium compounds on a mop head is known and attempts have been made to overcome this phenomenon. Some methods of overcoming quaternary ammonium compound depletion due to the absorption or adsorption include the direct application of the quaternary ammonium compound to the floor (instead of application by a mop head) or by the use of specific non-quaternary ammonium compound depleting textiles in the mop head. Each of the above may present its own difficulties. For example, if the solution is applied directly to the floor, it will subsequently be spread around the floor by a textile article that may tend to deplete quaternary ammonium compound. Non-quaternary ammonium compound depleting textiles often do not hold sufficient liquid to make them practical for use in mopping a floor.

Alternatively, it is possible to increase the quaternary ammonium compound level by lowering the dilution ratio, i.e., increasing the use concentration of the disinfectant, to overcome the depletion effect and thereby apply the desired level of quaternary ammonium compound to the floor. For example, if the antimicrobial composition concentrate contains 21.7% quaternary ammonium compound actives and has a recommended dilution ratio of 1 part antimicrobial composition to 255 parts water, the resulting level of active quaternary ammonium compound will be 848 ppm. This is typically the level (or a level slightly lower than it to account for manufacturing variances) of quaternary ammonium compound the composition was tested at to demonstrate activity against the organisms claimed needed for registration with the federal Environmental Protection Agency (“EPA”) for use in hospitals. While increasing the quaternary ammonium composition concentration is an effective way of delivering the necessary concentration of quaternary ammonium compound to a floor surface, it has been observed that quaternary ammonium compounds, after multiple treatments, cause the floor finish on the floor to degrade, i.e., soften, become sticky, or discolor. While this effect has been noted even with quat levels lower than intended, the stickiness has been observed to be more severe when the quat level is increased.

Hospital floors often consist of vinyl composition tile (VCT), sheet vinyl, linoleum, and terrazzo. The floors are often coated with a floor polish to protect the floor, provide a glossy appearance and to enable the surface to be repaired by methods such as buffing and burnishing. Typically the floors are coated with a floor finish when the tile is installed and then periodically after that as needed. Several coats are normally applied at one time. As normal traffic wear occurs, the finish becomes dull and scuffed. This requires the floor to be stripped and recoated. In hospitals this is commonly done once every 3 to 12 months, depending on traffic and room availability.

Some floor finishes, for example GLOSSTEK GT-100™ (Ecolab Inc.), are typically applied in one or more coats. These finishes may comprise one or more components that need to be combined prior to being applied to the floor. These finishes may take longer to dry than conventional finishes, but typically do not need to be stripped and recoated, or screened and recoated, as often. These finishes may or may not need to be buffed or burnished. These finishes also tend to have a much lower coverage rate (i.e. one gallon of product covers less square footage).

Softening of the floor finish or surface stickiness creates an undesirable sensory experience for people walking on the floor and may even cause people to stumble or trip due to a higher coefficient of friction on the floor. It also leads to increased soiling of the floor as dirt and other soils are attracted to the sticky floor. Increased soiling is visually undesirable, but also unhealthy in patient care facilities like hospitals, surgical centers, and nursing homes.

Currently, there are several types of floor finishes typically used in hospitals: ultradurable finishes based on polyol-isocyanate crosslinking of polyol functional polymers, acrylic finishes based on aziridine and/or isocyanate crosslinking, and traditional acrylic based floor finishes with and without polyurethane fortification (0 to 100%). There remains a need for a floor finish that is suitable for use in patient care locations, such as those described above, that is resistant to degradation by antimicrobial compositions, and quaternary ammonium compound-based compositions in particular. This is especially so when the concentration of the quaternary ammonium compound is increased in the use solution (for example in the mop bucket) in order to compensate for the absorption or adsorption of the quaternary ammonium compound on the mop head.

It is against this background that the present invention has been made.

### SUMMARY

Surprisingly, it has been discovered that certain floor finishes are resistant to degradation by antimicrobial compositions such as quaternary ammonium compounds. More specifically, it has been discovered that certain floor finishes described in the present invention are resistant to degradation by higher concentrations of quaternary ammonium compounds used to compensate for absorption or adsorption of the quaternary ammonium compound on a mop head. In other words, the floor finish composition does not become sticky over time when quaternary ammonium compound-based compositions are applied to the floor. In some aspects, the present invention provides a system and method of reducing microorganisms on a floor surface without the disadvantages of present systems, i.e., degradation of the floor finishes when used with an increased concentration of quaternary ammonium compound. For example, the system of the present invention allows for floor surfaces to be properly cleaned and disinfected without creating a sticky floor. As a result, the floor is safer, more pleasing to the eye, and provides a cleaner and healthier environment that has less dirt and microorganisms. The present invention also has the additional advantage of being resistant to other antimicrobial compositions typically found in patient care locations such as antimicrobial handsoaps and handwashes and in particular alcohol-based compositions and Glucoprotamin-based compositions. Alcohol-based antimicrobial compositions can be damaging to a floor finish when inadvertently dropped or allowed to drip onto a floor. The floor finishes for use with the methods of the present invention are also preferably resistant to degradation by these alcohol and Glucoprotamin-based compositions.

Accordingly, in some aspects, the present invention is directed to a method of treating floors. The method comprises: applying an antimicrobial resistant floor finish composition comprising a polyol-isocyanate crosslinked/crosslinkable polyurethane floor finish composition to a floor; applying a quaternary ammonium compound antimicrobial composition to a mop head, wherein the quaternary ammonium compound is present in an amount greater than necessary to disinfect Pseudomonas aeruginosa according to the AOAC Use Dilution test method; and transferring the quaternary ammonium compound composition from the mop head to the floor on a repeated daily basis, wherein at least enough quaternary ammonium compound needed to disinfect Pseudomonas aeruginosa according to the AOAC Use Dilution test method is transferred to the floor without substantially degrading the floor finish.

In some embodiments, the floor finish is resistant to quaternary ammonium compounds. In other embodiments, the floor finish is resistant to Glucoprotamin-based compositions. In yet other embodiments, the floor finish is resistant to alcohol-based compositions. In some embodiments the floor finish is resistant to quaternary ammonium compounds, and/or glucoprotamin-based compositions, and also alcohol or alcohol based compositions.

In some embodiments, the floor finish composition comprises a single floor finish. In other embodiments, the floor finish composition comprises multiple floor finishes.

In still other embodiments, the step of applying the floor finish composition comprises applying a single layer of a floor finish composition. In some embodiments, the step of applying the floor finish composition comprises applying multiple layers of a floor finish composition. In some embodiments, the floor finish composition applied in each layer is the same, and in other embodiments, the floor finish composition applied in at least one layer is different than the floor finish composition applied in another layer. In some embodiments, at least the top most layer comprises the antimicrobial resistant floor finish composition.

In other embodiments, the amount of quaternary ammonium compound applied to the mop head is at least about 1.5 times the amount necessary to disinfect Pseudomonas aeruginosa according to the AOAC Use Dilution test method. In yet other embodiments, the amount of quaternary ammonium compound applied to the mop head is at least about two times the amount necessary to disinfect Pseudomonas aeruginosa according to the AOAC Use Dilution test method.

In some embodiments, the mop head is a flat mop made of microfiber. In some embodiments, the floor is located in a patient care location. In other embodiments, the patient care location is a hospital, nursing home, surgical center, veterinary facility, dentist office, eye care office, clinic, long term care facility, or daycare.

In other aspects, the present invention provides a method of treating floors comprising: applying an antimicrobial resistant floor finish composition comprising a floor finish cross linked with aziridine to a floor; applying a quaternary ammonium compound antimicrobial composition to a mop head, wherein the quaternary ammonium compound is present in an amount greater than necessary to disinfect Pseudomonas aeruginosa according to the AOAC Use Dilution test method; and transferring the quaternary ammonium compound composition from the mop head to the floor on a repeated daily basis, wherein at least enough quaternary ammonium compound needed to disinfect Pseudomonas aeruginosa according to the AOAC Use Dilution test method is transferred to the floor without substantially degrading the floor finish. In some embodiments, the floor finish is selected from the group consisting of an acrylic floor finish, a zinc cross linked acrylic floor finish and mixtures thereof.

In some embodiments, the floor finish is resistant to quaternary ammonium compounds. In other embodiments, the floor finish is resistant to Glucoprotamin-based compositions. In yet other embodiments, the floor finish is resistant to alcohol-based compositions. In some embodiments the floor finish is resistant to quaternary ammonium compounds, and/or glucoprotamin-based compositions, and also alcohol or alcohol based compositions.

In some embodiments, the floor finish composition comprises a single floor finish. In other embodiments, the floor finish composition comprises multiple floor finishes.

In still other embodiments, the step of applying the floor finish composition comprises applying a single layer of a floor finish composition. In some embodiments, the step of applying the floor finish composition comprises applying multiple layers of a floor finish composition. In some embodiments, the floor finish composition applied in each layer is the same, and in other embodiments, the floor finish composition applied in at least one layer is different than the floor finish composition applied in another layer. In some embodiments, at least the top most layer comprises the antimicrobial resistant floor finish composition.

In other embodiments, the amount of quaternary ammonium compound applied to the mop head is at least about 1.5 times the amount necessary to disinfect Pseudomonas aeruginosa according to the AOAC Use Dilution test method. In yet other embodiments, the amount of quaternary ammonium compound applied to the mop head is at least about two times the amount necessary to disinfect Pseudomonas aeruginosa according to the AOAC Use Dilution test method.

In some embodiments, the mop head is a flat mop made of microfiber. In some embodiments, the floor is located in a patient care location. In other embodiments, the patient care location is a hospital, nursing home, surgical center, veterinary facility, dentist office, eye care office, clinic, long term care facility, or daycare.

In other aspects, the present invention provides a method of treating floors comprising: applying an antimicrobial resistant floor finish composition comprising a zinc free acrylic floor finish to a floor; applying a quaternary ammonium compound antimicrobial composition to a mop head, wherein the quaternary ammonium compound is present in an amount greater than necessary to disinfect Pseudomonas aeruginosa according to the AOAC Use Dilution test method; and transferring the quaternary ammonium compound composition from the mop head to the floor on a repeated daily basis, wherein at least enough quaternary ammonium compound needed to disinfect Pseudomonas aeruginosa according to the AOAC Use Dilution test method is transferred to the floor without substantially degrading the floor finish.

In some embodiments, the floor finish is resistant to quaternary ammonium compounds. In other embodiments, the floor finish is resistant to Glucoprotamin-based compositions. In yet other embodiments, the floor finish is resistant to alcohol-based compositions. In some embodiments the floor finish is resistant to quaternary ammonium compounds, and/or glucoprotamin-based compositions, and also alcohol or alcohol based compositions.

In some embodiments, the floor finish composition comprises a single floor finish. In other embodiments, the floor finish composition comprises multiple floor finishes.

In still other embodiments, the step of applying the floor finish composition comprises applying a single layer of a floor finish composition. In some embodiments, the step of applying the floor finish composition comprises applying multiple layers of a floor finish composition. In some embodiments, the floor finish composition applied in each layer is the same, and in other embodiments, the floor finish composition applied in at least one layer is different than the floor finish composition applied in another layer. In some embodiments, at least the top most layer comprises the antimicrobial resistant floor finish composition.

In other embodiments, the amount of quaternary ammonium compound applied to the mop head is at least about 1.5 times the amount necessary to disinfect Pseudomonas aeruginosa according to the AOAC Use Dilution test method. In yet other embodiments, the amount of quaternary ammonium compound applied to the mop head is at least about two times the amount necessary to disinfect Pseudomonas aeruginosa according to the AOAC Use Dilution test method.

In some embodiments, the mop head is a flat mop made of microfiber. In some embodiments, the floor is located in a patient care location. In other embodiments, the patient care location is a hospital, nursing home, surgical center, veterinary facility, dentist office, eye care office, clinic, long term care facility, or daycare.

These and other aspects and embodiments will be apparent to those of skill in the art and others in view of the following detailed description of various embodiments. It should be understood, however, that this summary, and the detailed description illustrate only some examples of various embodiments, and are not intended to be limiting to the invention as claimed.

### BRIEF DESCRIPTION OF THE DRAWINGS

FIG. 1 graphically depicts the quaternary ammonium compound level in application solution as a function of mop soaking time.

FIG. 2 graphically depicts the zinc content impact on the delta L value of several floor finishes.

FIG. 3 graphically depicts the impact of A45611 on the Tg onset of floor finish films.

FIG. 4 graphically depicts the impact of A456N on the Tg onset of floor finish films.

FIG. 5 graphically depicts the impact of A45611 on the TGA weight loss percentage.

FIG. 6 graphically depicts the impact of A456N on the TGA delta weight loss percentage.

### DETAILED DESCRIPTION

As discussed above, in some aspects, the present invention generally relates to a system and method of reducing the presence of microorganisms on a floor without degrading the floor finish on the floor. In some aspects, the present invention includes an antimicrobial resistant floor finish composition and a quaternary ammonium composition with an increased concentration of active quaternary ammonium compound where the two compositions, when used together, create a system for effectively disinfecting a floor without substantially degrading the floor finish. In other aspects, the present invention includes a method of disinfecting a floor, where a floor finish composition is applied to a floor and thereafter, a quaternary ammonium compound-based antimicrobial composition is applied to the floor to reduce the microorganism population on the floor surface, without substantially degrading the floor finish.

Floor finishes for use in patient care locations are known, as is the use of quaternary ammonium compounds for reducing the presence of microorganisms on floors. See e.g., APIC Guideline for Selection and Use of Disinfectants, AJIC, Vol. 24, No. 4, pp. 313-342, August 1996; W. A. Rutala and D. J. Weber, Surface disinfection: should we do it?, Journal of Hospital Infection Control (2001) 48 (Supplement A): S64-S68; D. MacDougall and C. Morris, Optimizing Disinfectant Application in Healthcare Facilities, Infection Control Today, June 2006, pp. 62-66; Using Microfiber Mops in Hospitals, US EPA, Environmental Best Practices for Health Care Facilities, November 2002. In some aspects, the present invention is directed to the unexpected discovery that certain floor finishes are especially compatible with antimicrobial compositions, e.g., quaternary ammonium compounds, used to disinfect the floors, That is, the floor finishes for use in the methods of the present invention are not substantially degraded by the use of antimicrobial compositions. Methods for treating floors comprising applying an antimicrobial resistant floor finish composition and a quaternary ammonium compound antimicrobial composition are also provided herein.

### DEFINITIONS

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

As used herein, the terms “weight percent,” “percent by weight,” “% by weight,” “wt %,” and the like are synonyms that refer to the concentration of a substance as the weight of that substance divided by the weight of the composition and multiplied by 100.

The recitation of numerical ranges by endpoints includes all numbers and ranges subsumed within that range (e.g. 1 to 5 includes 1, 1.5, 2, 2.75, 3, 3.80, 4 and 5).

As used in this specification and the appended claims, the singular forms “a,” “an,” and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

The use of the terms “antimicrobial” in this application does not mean that any resulting products are approved for use as an antimicrobial agent. Further, the use of the words “disinfect,” “disinfecting,” and the like generically refer to the reduction of microorganisms and are not meant to imply a specific log reduction unless specifically stated otherwise.

### Floor Finish Composition

In some aspects, the present invention advantageously uses an antimicrobial resistant floor finish composition. As used herein, the term “antimicrobial resistant floor finish composition,” refers to a floor finish that does not substantially degrade when in contact with antimicrobial compositions, e.g., quaternary ammonium compositions. That is, the floor finishes for use with the methods of the present invention do not become soft or sticky to the touch after contact with an antimicrobial composition. In some embodiments, the floor finishes for use in the methods of the present invention are resistant, i.e., they do not substantially degrade, to antimicrobial compositions commonly found in patient care locations. Such compositions include, but are not limited to, quaternary ammonium compositions, alcohol or alcohol based compositions, and Glucoprotamin based compositions.

In some embodiments, the floor finish composition may be part of a single layer of antimicrobial resistant floor finish that is applied to the floor. In other embodiments, the floor finish composition may be applied in multiple layers of antimicrobial resistant floor finish. In some embodiments, the floor finish composition described herein may be part of multiple floor finish layers where other layers of floor finish are sensitive or subject to degradation by antimicrobial compositions and the antimicrobial resistant floor finish described herein is applied as the topmost layer.

Antimicrobial resistant floor finish compositions for use with the methods of the present invention include, but are not limited to, acrylic based floor finishes, aziridine crosslinked acrylic based floor finishes, epoxy crosslinked floor finishes, polyurethane dispersions, polyol-isocyanate cross linked polyurethane finishes, and mixtures and combinations thereof. Other antimicrobial resistant floor finish compositions for use with the present invention include, but are not limited to, commercially available floor finishes, e.g., zinc cross linked acrylic based floor finishes, zinc free acrylic based floor finishes, urethane fortified acrylic based floor finishes, aziridine based floor finishes, and mixtures and combinations thereof.

Representative commercially available floor finishes include, but are not limited to, TAJ MAHAL™ acrylic floor finish, GLOSSTEK 100™ polyurethane floor finish, and COURTMASTER II™, ISI STAR™, TUKLAR MEDICAL™, LASER™, ECOLAB ZINC FREE FLOOR FINISH™, FIRST BASE™, FLOORSTAR PREMIUM 25™, and MARKETSTAR™ floor finishes, all from Ecolab Inc.; ENVIROSTAR™ available from Pioneer Eclipse Corp.; ES80 HIGH GLOSS™ available from Enviro-Solutions Ltd.; AQUARIA™, SIGNATURE™, HIGH MILEAGE™, AND AMPLIFY™ available from Johnson Wax Professional; SPARTAN GREEN SOLUTIONS™ available from Spartan Chemical Co.; CASTLEGUARD™ acrylic finish from Buckeye International, Inc.; COMPLETE™, SIGNATURE™, TECHNIQUE™ and VECTRA™ acrylic floor finishes from SC Johnson Professional Products; and PREMIER™ acrylic finish from MinuteMan International, Inc.

In some aspects of the present invention, a polyol-isocyanate cross linked/crosslinkable polyurethane floor finish is applied to a floor. The polyurethane floor finish may be a one-part preformed polyurethane composition. In other embodiments, the polyurethane floor finish may be a multi-part polyurethane forming coating system which can be mixed on-site. In some embodiments, the polyol-isocyanate cross linked/crosslinkable polyurethane floor finish applied is LQW47-100DM™ (Henkel Corp.), GLOSSTEK GT 100™, and mixtures thereof.

In some aspects of the present invention, a floor finish cross linked with aziridine is applied to a floor. The floor finish composition can be a two-part, crosslinkable coating system which can be mixed on-site. In some embodiments, the floor finish cross linked with aziridine is an acrylic floor finish. In some embodiments, the floor finish cross linked with aziridine is a zinc cross linked acrylic floor finish. For example, MARKETSTAR™ cross linked with aziridine, FLOORSTAR PREMIUM 25™ cross linked with aziridine, TUKLAR MEDICAL™ cross linked with aziridine, and/or LASER™ cross linked with aziridine may be applied to a floor. Any floor finish capable of being cross linked with aziridine may be used with the methods of the present invention.

The acrylic based class of floor finishes of the present invention include an acrylic polymer as the film former. Acrylic based floor finishes for use with the present invention are, in some embodiments, formulated with a low acid number and/or are zinc free acrylic based floor finishes. In other embodiments, acrylic based floor finishes formulated with the polymer Duragreen™ MF1 (Rohm and Haas Co.) are used with the methods of the present invention. Exemplary acrylic film formers include water-soluble or water dispersible (as is or with a dispersing agent) acid-containing polymers crosslinked using transition metals, alkaline earth metals, alkali metals or mixtures thereof (e.g., zinc crosslinked acrylics); zinc-free acrylic finishes (e.g., acrylic copolymers); acrylic urethanes; hydroxy containing polyacrylates; acrylic polymers crosslinked with isocyanate or aziridine based crosslinkers, and a variety of other materials that will be familiar to those skilled in the art. For a more complete discussion of acrylic polymers, see U.S. Pat. Nos. 6,228,913, 6,319,977, and 6,855,403, the entire disclosures of which are hereby incorporated by reference.

Representative commercially available film formers include DURAPLUS™ 3 zinc crosslinked acrylic dispersion, DURAPLUS 2 zinc crosslinked acrylic dispersion, RHOPLEX B-924 zinc crosslinked acrylic dispersion, RHOPLEX NT-2624 acrylic dispersion, DURAGREEN acrylic dispersion, RHOPLEX NTS-2923 acrylic dispersion, RHOPLEX 3949 acrylic dispersion, RHOPLEX™ 1421 zinc crosslinked acrylic dispersion, RHOPLEX 3830 zinc crosslinked acrylic dispersion, and UHS PLUS zinc crosslinked acrylic dispersion from Rohm & Haas Co.; MEGATRAN™ 205 zinc crosslinked acrylic dispersion and SYNTRAN™ 1580 zinc crosslinked acrylic dispersion from Interpolymer Corp.; MORGLO™ zinc crosslinked acrylic dispersion, ML-870 zinc crosslinked acrylic dispersion and ML-877 zinc crosslinked acrylic dispersion from Omnova Solutions Inc.; 98-283W urethane acrylate from Hans Rahn & Co.; and materials such as those described in U.S. Pat. Nos. 4,517,330, 4,999,216, 5,091,211, 5,319,018, 5,453,451, 5,773,487, 5,830,937, 6,096,383, 6,197,844, 6,228,433, 6,316,535 B1, 6,544,942 B1, U.S. Patent Application Publication No. U.S. 2002/0028621 A1, and in the patents cited therein, the complete disclosures of which are hereby incorporated by reference in their entirety. In some embodiments, the floor finish composition uses a single film former, e.g., an acrylic based film former is the exclusive film former in the floor finish composition. In other embodiments, a mixture of film formers is used in the floor finish composition.

### Floor Maintenance Components

In addition to the acrylic based film former, the floor finish composition may also include conventional floor-maintenance components known to those skilled in the art. For example, the floor finish compositions may also comprise waxes, surfactants, diluents, solvents, surface slip modifiers, defoamers, indicators, UV absorbers/light stabilizers/antioxidants, plasticizers, coalescents, adhesion promoters, preservatives/antimicrobial agents, levelling agents, thickeners, stability enhancers, dispersants, colorants, anti-settling agents, matting agents, optical brighteners, alkali soluble resins, polyurethane dispersions/film fortification agents and mixtures thereof.

Some non-limiting examples of suitable waxes include oxidized polyethylenes and polypropylenes and copolymers thereof. Examples of waxes include Polypropylene Emulsion 43N40, Polypropylene Emulsion 43G40SP, Polyethylene Emulsion 325G, commercially available from Michelman Inc (Cincinnati, Ohio) and ChemCor (Chester, N.J.), Syntran 1445 and Syntran 1465, commercially available from Interpolymer Corp (Canton, Mass.).

Some non-limiting examples of surface slip modifiers include organic or inorganic particles incorporated in the finish itself to reduce slipping.

Some non-limiting examples of defoamers include silicon emulsions such as SE-21 from Wacker Silicons.

Some non-limiting examples of indicators include acid/base indicators, fluorescent indicators, redox indicators, metallochromic indicators, and photon sensitive dyes.

Some non-limiting examples of UV absorbers, light stabilizers, or antioxidants include hindered amine types such as TINUVIN 123, TINUVIN 152, or CHIMASSORB 199, benzotriazole types such as TINUVIN 171, TINUVIN 384-2, or TINUVIN 1130, TINUVIN 400, TINUVIN 5050 or IRGANOX 1076, all available from Ciba Specialty Chemicals.

Some non-limiting examples of adhesion promoters include promoters based on silanes and silicones such as DYNASYLAN® from Degussa.

Some non-limiting examples of preservatives and antimicrobials include isothazoline derivatives such as KATHON CG-ICP (Rohm & Haas) and silver compounds or triclosan from Ciba.

Some non-limiting examples of wetting or levelling agents include fluorosurfactants such as Zonyl FSJ, FSN or FSO (Dupont), or MASURF FS-230 (Mason Chemical).

Some non-limiting examples of thickeners include polymeric thickeners from Rohm & Haas.

Some non-limiting examples of stability enhancers include anionic surfactants such as ABEX 18S (Rhodia).

Some non-limiting examples of dispersants or anti-settling agents include fumed silicas; starch and modified starches; hydroxyethylcellulose (HEC) and functionalized copolymers such as alkali swellable emulsions (ASE), hydrophobically modified alkali swellable emulsions (RASE) and hydrophobically modified ethoxylated urethane resins (HEUR).

Some non-limiting examples of colorants include organic and/or inorganic dyes, pigments or lightness inducing agents.

Some non-limiting examples of resins include alkali soluble resins, styrene maleic anhydride copolymers, rosin esters, and acrylic oligomers. Examples include solutions of CHEMREZ 30, CONREZ 510, and RESINALL 802, commercially available from ChemCor.

Some non-limiting examples of film fortification agents include polyurethane dispersions, such as CUR 96 VP from Alberdingk, and NEOPAC R-9699 and NEOREZ R-2150 from Neoresins.

The floor finish compositions may also contain water or another suitable diluent, plasticizer or coalescent, including compounds such as: benzyloxyethanol; an ether or hydroxyether such as ethylene glycol phenyl ether (commercially available as “DOWANOL EPh” from Dow Chemical Co.) or propylene glycol phenyl ether (commercially available as “DOWANOL PPh” from Dow Chemical Co.); tributoxyl ethyl phosphate (commercially available as AMGARD TBEP from Albright & Wilson); ester alcohols (commercially available as Texanol and TXIB from Eastman); benzoate esters (commercially available as Benzoflex from Velsicol); citric acid esters; dibasic esters such as dimethyl adipate, dimethyl succinate, dimethyl glutarate dimethyl malonate, diethyl adipate, diethyl succinate, diethyl glutarate, dibutyl succinate, and dibutyl glutarate (including products available under the trade designations DBE, DBE-3, DBE-4, DBE-5, DBE-6, DBE-9, DBE-IB, and DBE-ME from DuPont Nylon); dialkyl carbonates such as dimethyl carbonate, diethyl carbonate, dipropyl carbonate, diisopropyl carbonate, and dibutyl carbonate; phthalate esters such as dibutyl phthalate, diethylhexyl phthalate, and diethyl phthalate; and mixtures thereof. Cosolvents can also be added if desired to assist in formulating and applying the finish. Suitable cosolvents include, for example, Butoxyethyl PROPASOL™, Butyl CARBITOL™ acetate, Butyl CARBITOL™, Butyl CELLOSOLVE™ acetate, Butyl CELLOSOLVE™, Butyl DIPROPASOL™, Butyl PROPASOL™, CARBITOL™ PM-600, CARBITOL™ Low Gravity, CELLOSOLVE™ acetate, CELLOSOLVE™, Ester EEP™, FILMER IBT™, Hexyl CARBITOL™, Hexyl CELLOSOLVE™, Methyl CARBITOL™, Methyl CELLOSOLVE™ acetate, Methyl CELLOSOLVE™, Methyl DIPROPASOL™, Methyl PROPASOL™ acetate, Methyl PROPASOL™, Propyl CARBITOL™, Propyl CELLOSOLVE™, Propyl DIPROPASOL™ and Propyl PROPASOL™, all of which are available from Union Carbide Corp., and mixtures thereof.

The coating system may also contain inorganic and/or organic particles to enhance its abrasion resistance, scratch resistance, wear resistance, appearance, or strippability. Preferred inorganic particles are described in U.S. patent application Ser. No. 09/657,420 filed Sep. 8, 2000 and entitled SCRATCH-RESISTANT STRIPPABLE FINISH, the entire disclosure of which is hereby incorporated by reference. In addition, the coating system may include lightness inducing agents such as those described in patent application Ser. No. 11/033,029 filed Jan. 11, 2005 and entitled FLOOR FINISH COMPOSITION, LAMINATES, AND METHODS FOR TREATING FLOORS, the entire disclosure of which is hereby incorporated by reference.

### Quaternary Ammonium Compound Composition

As used herein, the term “quaternary ammonium compound composition,” “quaternary ammonium compound antimicrobial composition” or “quaternary ammonium composition” refers to a composition for use with the present invention that comprises a quaternary ammonium compound, and has an antimicrobial effect, i.e., is capable of reducing the population of the target microorganisms. The term “quaternary ammonium compound” or “quat” generally refers to a compound of the formula

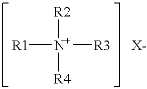

where R₁-R₄ are alkyl groups that may be alike or different, substituted or unsubstituted, saturated or unsaturated, branched or unbranched, and cyclic or acyclic and may contain ether, ester, or amide linkages, or they may be aromatic or substituted aromatic groups. X⁻ is an anionic counterion. Certain quats are known to have antimicrobial activity. Accordingly, any quaternary ammonium compound with antimicrobial activity can be used in the present invention to reduce microorganisms on a floor.

Depending on the nature of the R group, the anion, and the number of quaternary nitrogen atoms present, the antimicrobial quats may be classified into one of the following categories: (1) monoalkyltrimethyl ammonium salts; (2) monoalkyldimethylbenzyl ammonium salts; (3) dialkyldimethyl ammonium salts; (4) heteroaromatic ammonium salts; (5) polysubstituted quaternary ammonium salts; (6) bis-quaternary ammonium salts; and (7) polymeric quaternary ammonium salts. Each category will be discussed herein.

Monoalkyltrimethyl ammonium salts contain one R group that is a long-chain alkyl group, and the remaining R groups are short-chain alkyl groups, such as methyl or ethyl groups. Some non-limiting examples of monoalkyltrimethyl ammonium salts include cetyltrimethylammonium bromide, commercially available as Rhodaquat M242C/29 from Rhodia (Laurenceville, Ga.) and Dehyquart A from Henkel Corp. (Cincinnati, Ohio); alkyltrimethyl ammonium chloride, commercially available as Arquad 16 from Akzo Nobel Chemicals Inc. (Chicago, Ill.); alkylaryltrimethyl ammonium chloride; and cetyldimethyl ethylammonium bromide, commercially available as Ammonyx DME from Stepan Co. (Northfield, Ill.), and Bretol from Zeeland Chemical Inc. (Zeeland, Mich.).

Monoalkyldimethylbenzyl ammonium salts contain one R group that is a long-chain alkyl group, a second R group that is a benzyl radical, and the two remaining R groups are short-chain alkyl groups, such as methyl or ethyl groups. Monoalkyldimethylbenzyl ammonium salts are generally compatible with nonionic surfactants, detergent builders, perfumes, and other ingredients. Some non-limiting examples of monoalkyldimethylbenzyl ammonium salts include alkyldimethylbenzyl ammonium chlorides, commercially available as BTC 824 from Stepan Company (Northfield, Ill.), Hyamine 3500 from Lonza Inc. (Fair Lawn, N.J.), and Barquat® MB-80 from Lonza Inc. (Fair Lawn, N.J.); and benzethonium chloride, commercially available as Lonzagard, from Lonza Inc. (Fair Lawn, N.J.). Additionally, the monoalkyldimethylbenzyl ammonium salts may be substituted. Non-limiting examples of such salts include dodecyldimethyl-3,4-dichlorobenzyl ammonium chloride. Finally, there are mixtures of alkyldimethylbenzyl and alkyldimethyl substituted benzyl (ethylbenzyl) ammonium chlorides commercially available as BTC 2125M from Stepan Company (Northfield, Ill.), and Barquat 4250 from Lonza Inc. (Fair Lawn, N.J.).

Dialkyldimethyl ammonium salts contain two R groups that are long-chain alkyl groups, and the remaining R groups are short-chain alkyl groups, such as methyl groups. Some non-limiting examples of dialkyldimethyl ammonium salts include didecyldimethyl ammonium halides, commercially available as Bardac 22 from Lonza Inc. (Fair Lawn, N.J.); didecyl dimethyl ammonium chloride commercially available as Bardac™ 2250 or 2280 from Lonza Inc. (Fair Lawn, N.J.); dioctyl dimethyl ammonium chloride, commercially available as Bardac™ LF and Bardac™ LF-80 from Lonza Inc. (Fair Lawn, N.J.); and octyl decyl dimethyl ammonium chloride sold as a mixture with didecyl and dioctyl dimethyl ammonium chlorides, commercially available as Bardac™ 2050 and 2080 from Lonza Inc. (Fair Lawn, N.J.).

Heteroaromatic ammonium salts contain one R group that is a long-chain alkyl group, and the remaining R groups are provided by some aromatic system. Accordingly, the quaternary nitrogen to which the R groups are attached is part of an aromatic system such as pyridine, quinoline, or isoquinoline. Some non-limiting examples of heteroaromatic ammonium salts include cetylpyridinium halide, commercially available as Sumquat 6060/CPC from Zeeland Chemical Inc. (Zeeland, Mich.); 1-[3-chloroalkyl]-3,5,7-triaza-1-azoniaadamantane, commercially available as Dowicil 200 from The Dow Chemical Company (Midland, Mich.); and alkyl-isoquinolinium bromide.

Polysubstituted quaternary ammonium salts are a monoalkyltrimethyl ammonium salt, monoalkyldimethylbenzyl ammonium salt, dialkyldimethyl ammonium salt, or heteroaromatic ammonium salt wherein the anion portion of the molecule is a large, high-molecular weight (MW) organic ion. Some non-limiting examples of polysubstituted quaternary ammonium salts include alkyldimethyl benzyl ammonium saccharinate, commercially available as Onyxide 3300 from Stepan Company (Northfield, Ill.); and dimethylethylbenzyl ammonium cyclohexylsulfamate, commercially available as Onyxide 172 from Stepan Company (Northfield, Ill.).

Bis-quaternary ammonium salts contain two symmetric quaternary ammonium moieties having the general formula:

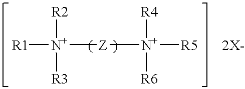

Here the R groups may be long or short chain alkyl, a benzyl radical or provided by an aromatic system. Z is a carbon-hydrogen chain attached to each quaternary nitrogen. Some non-limiting examples of bis-quaternary ammonium salts include 1,10-bis(2-methyl-4-aminoquinolinium chloride)-decane; and 1,6-bis[1-methyl-3-(2,2,6-trimethyl cyclohexyl)-propyldimethylammonium chloride] hexane or triclobisonium chloride.

A wide variety of different types of polymeric quaternary ammonium salts are known. Some non-limiting examples of polymeric quaternary ammonium salts include the following:

A. Tonenes having the following structure:

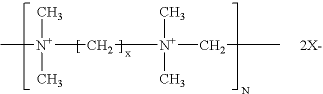

B. Poly[oxyethylene(dimethyliminio)ethylene(dimethyliminio)ethylene dichloride], having the following structure:

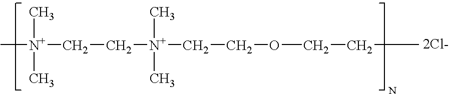

C. Polyquaternium 2 CTFA, having the following structure and are commercially available as Mirapol-A15 from Rhodia Inc. (Lawrenceville, Ga.):

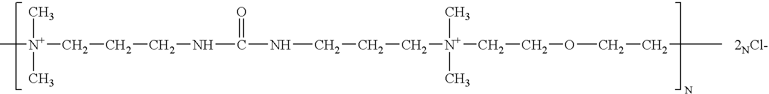

D. Polyquaternium 1 CTFA, having the following structure:

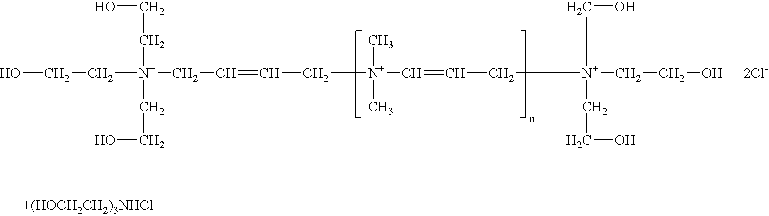

The long-chain alkyl R groups in the previously described quats have from about 8 carbons to about 18 carbons, from about 10 to about 18 carbons, and from about 12 to about 16 carbons. Such quats are both soluble and good antimicrobial agents.

The term “anionic counterion” includes any ion that can form a salt with quaternary ammonium. Examples of suitable counterions include halides such as chlorides and bromides, propionates, carbonates, methosulphates, saccharinates, ethosulphates, hydroxides, acetates, phosphates, and nitrates. Preferably, the anionic counterion is chloride.

The quaternary ammonium compound is preferably selected from the following classes: monoalkyldimethylbenzyl ammonium salts, dialkyldimethyl ammonium salts, polysubstituted quaternary ammonium salts, and bis-quaternary ammonium salts, with the monoalkyldimethylbenzyl ammonium salts being the most preferred. The quaternary ammonium compound is preferably benzalkonium chloride or benzethonium chloride.

Additives

In addition to the quaternary ammonium compound, the quaternary ammonium composition may also contain other additives. For example, the quaternary ammonium composition may also contain surfactants, additional antimicrobial agents, flow controllers, complexing agents/chelating agent, solvents, builders, pH adjusting agents such as sources of alkalinity, acids, and buffers, solubilizers, dyes, perfumes, thickeners, and mixtures thereof.

The composition may optionally include a chelating agent, sequestering agent, or builder. These ingredients generally provide cleaning properties and chelating properties. Exemplary detergent builders that may be used include sodium hydroxide, sodium metasilicate, potassium hydroxide, sodium carbonate, sodium sulphate, sodium chloride, starch, sugars, C₁-C₁₀ alkylene glycols such as propylene glycol, and the like. Exemplary chelating agents that may be used include phosphates, phosphonates, carboxylates, and amino-acetates. Exemplary phosphates that may be used include sodium orthophosphate, potassium orthophosphate, sodium pyrophosphate, potassium pyrophosphate, sodium tripolyphosphate (STPP), and sodium hexametaphosphate. Exemplary phosphonates that may be used include 1-hydroxyethane-1,1-diphosphonic acid.

Some non-limiting examples of surfactants include nonionic, cationic, anionic, and amphoteric surfactants such as alcohol ethoxylates, lauramine oxides, disodium laurylamphodipropionate, lauryl sarcosinate, and nonylphenol ethoxylate.

Some non-limiting examples of solvents include dipropylene glycol, n-butyl ether, propylene glycol methyl ether.

Some non-limiting examples of pH adjusting agents include acids such as citric acid, phosphoric acid, methane sulfonic acid, and sulfamic acid; alkaline materials such as potassium hydroxide, sodium hydroxide, and carbonate; and buffers such as sodium bicarbonate, sodium tripolyphosphate, potassium carbonate, and sodium citrate.

Some non-limiting examples of thickeners include organic and inorganic thickeners. Of the organic thickeners there are (1) cellulosic thickeners and their derivatives, (2) natural gums, (3) acrylates, (4) starches, (5) stearates, and (6) fatty acid alcohols. Of the inorganic thickeners there are (7) clays, and (8) salts. Some non-limiting examples of cellulosic thickeners include carboxymethyl hydroxyethylcellulose, cellulose, hydroxybutyl methylcellulose, hydroxyethylcellulose, hydroxypropylcellulose, hydroxypropyl methyl cellulose, methylcellulose, microcrystalline cellulose, sodium cellulose sulfate, and the like. Some non-limiting examples of natural gums include acacia, calcium carrageenan, guar, gelatin, guar gum, hydroxypropyl guar, karaya gum, kelp, locust bean gum, pectin, sodium carrageenan, tragacanth gum, xanthan gum, and the like. Some non-limiting examples of acrylates include potassium aluminum polyacrylate, sodium acrylate/vinyl alcohol copolymer, sodium polymethacrylate, and the like. Some non-limiting examples of starches include oat flour, potato starch, wheat flour, wheat starch, and the like. Some non-limiting examples of stearates include methoxy PEG-22/dodecyl glycol copolymer, PEG-2M, PEG-5M, and the like. Some non-limiting examples of fatty acid alcohols include caprylic alcohol, cetearyl alcohol, lauryl alcohol, oleyl alcohol, palm kernel alcohol, and the like. Some non-limiting examples of clays include bentonite, magnesium aluminum silicate, magnesium trisilicate, stearalkonium bentonite, tromethamine magnesium aluminum silicate, and the like. Some non-limiting examples of salts include calcium chloride, sodium chloride, sodium sulfate, ammonium chloride, and the like.

The quaternary ammonium composition may be in the form of a concentrate composition or a ready to use composition. The concentrate composition refers to the composition that is diluted to form a ready to use composition. The ready to use composition refers to the composition that is applied to a surface. The ready to use composition is preferably in the form of a water-thin liquid, thickened liquid, solution, emulsion including a microemulsion and macroemulsion, suspension or gel, but may also be in the form of a solid such as a block, or powder. The concentrate composition may be a solid such as a block, sheet, powder, tablet, pellet, paste, or prill. The concentrate composition may also be a liquid such as a water-thin liquid, thickened liquid, structured liquid, solution, emulsion including a microemulsion and macroemulsion, suspension, or gel. The concentrate composition may be multiple phases where part of the concentrate is provided in one physical form (i.e., a solid) and another part of the concentrate is provided in second, different, physical form (i.e., a gel or thickened liquid). The concentrate composition may be designed to provide multiple uses such as a solid block weighing between about 10 g and about 25 kilograms that is diluted with various types of water, such as deionized water, hard water, soft water, or tap water to form a use solution and dispensed into a mop bucket. Alternatively, the concentrate composition may be designed to be single use such as a tablet or other concentrated product in a water soluble/swellable/dispersible form that is designed to be dropped in a mop bucket and dissolve. Examples of quaternary ammonium composition are described in greater detail in the Lonza Formulation Portfolio (copyright December 2005) or in U.S. patent application Ser. No. 10/518,422 directed to an AQUEOUS CONCENTRATE FOR THE DISINFECTION OF SURFACES, the entire disclosure of which is hereby incorporated by reference.

The concentration of active quaternary ammonium compound in a composition is determined by the concentration needed to reduce a target microorganism. This is often controlled by federal regulatory agencies that regulate antimicrobial products, such as the EPA. A person skilled in the art of antimicrobial compositions will be able to determine the concentration of quaternary ammonium compound in the composition needed to provide a satisfactory reduction in the targeted microorganism population. The required concentration of a specific disinfectant composition typically is that needed to pass the AOAC Use-Dilution Disinfectant test method as referred to by EPA DSS/TSS-1.

### Methods of Use

The present invention generally refers to a system or method for treating floors. In some aspects, an antimicrobial resistant floor finish is applied to a floor surface and allowed to harden. A quaternary ammonium compound antimicrobial composition is then applied to a mop head. When the quaternary ammonium composition is applied to a mop head, the concentration of the quaternary ammonium composition is more than the amount necessary to reduce the population of a target microorganism on the surface of the floor. For example, the quaternary ammonium compound may be present at least about 1.5 times the amount necessary to reduce the population of the target organism. Increasing the concentration of the quaternary ammonium compound antimicrobial composition on the mop head allows for a portion of the quaternary ammonium composition to absorb or adsorb onto the mop head without compromising the minimum concentration of active quaternary ammonium compound that needs to be transferred to the floor to effectively reduce the presence of microorganisms on the floor. After the quaternary ammonium composition is applied to the mop head, an amount of the quaternary ammonium composition that is applied to the mop head is transferred to the floor. The actual amount of quaternary ammonium composition that is transferred to the floor is at least enough to pass the EPA DSS/TSS-1 AOAC Use Dilution test against Pseudomonas aeruginosa. This would normally be the nominal concentration stated on the label diluted per label directions. If a dilution range is stated, it would be at the maximum dilution rate.

The floor finish composition can be applied to a variety of floor substrates. Representative flooring substrates include, for example, resilient substrates such as sheet goods (e.g., vinyl flooring, linoleum or rubber sheeting), vinyl composite tiles, vinyl asbestos tiles, rubber tiles, cork and synthetic sports floors, and non-resilient substrates such as concrete, stone, marble, wood, bamboo, ceramic tile, grout, Terrazzo and other poured or “dry shake” floors. The floor finish composition may be jobsite-applied to a flooring substrate after the substrate has been installed (e.g., to monolithic flooring substrates such as sheet vinyl goods, linoleum, cork, rubber sheeting, synthetic sports floors, concrete, stone, marble, grout or Terrazzo, or to multipiece flooring substrates such as vinyl composite tiles, wood floorboards or ceramic tiles), or can be factory-applied to a flooring substrate before it is installed (e.g., to monolithic flooring substrates such as sheet vinyl goods in roll form, or multipiece flooring substrates such as vinyl composite tiles or wood floorboards). Jobsite application is especially preferred, with suitable jobsites including indoor and outdoor sites involving new or existing residential, commercial and government- or agency-owned facilities.

The disclosed floor finish composition can be applied using a variety of methods and tools, including spraying, brushing, flat or string mopping, roll coating, applying with a paint roller, applying with a T-bar applicator, and flood coating. Mop application, especially flat mopping, is preferred for coating most floors. Suitable mops include those described in U.S. Pat. Nos. 5,315,734, 5,390,390, 5,680,667 and 5,887,311, the complete disclosures of which are hereby incorporated by reference in their entirety.

Typically, the floor should first be cleaned and any loose debris removed. In some embodiments, no undercoat layer or coat is applied to the floor. In other embodiments, one or more undercoat layers or coats (diluted if necessary with water or another suitable diluent, plasticizer, coalescent or cosolvent) may be applied to the floor. In yet other embodiments, one to three undercoat layers typically will be preferred.

When multiple undercoat layers are employed they can be the same or different. Each undercoat layer preferably will have a dry coating thickness of about 2.5 to about 25 microns, more preferably about 2.5 to about 15 microns. Preferably the overall undercoat dry coating thickness will be about 5 to about 100 microns, and more preferably about 5 to about 50 microns. If an undercoat is used, a topcoat may also be used. The topcoat may be the same as the undercoat or may be different. When a topcoat is used, one to seven layers typically will be preferred. Each topcoat layer will preferably have a dry coating thickness of about 2.5 to about 100 microns, more preferably from about 2.5 to 60 microns. It is to be understood that all values and ranges between these values and ranges are meant to be encompassed by the present invention.

Some non-limiting examples of suitable mop heads include string mops such as those available from Amsan; and flat mops such as those available from Rubbermaid, Unger or Ecolab. The mop head material can be made of for example, cotton, rayon, polyester, nylon or a combination thereof. The mop head is preferably a flat mop made of polyester and nylon microfiber.

In some embodiments of the present invention, when the floor is disinfected with quaternary ammonium compound antimicrobial composition, the composition will be applied with a mop head. The mop head can be similar to the mop head used to apply the floor finish, i.e., the mop head can be a string mop or a flat mop and made out of cotton, rayon, polyester, nylon or a combination thereof. The mop head is preferably a flat mop made of polyester and nylon microfiber.

Prior to disinfecting the floor, a use solution of quaternary ammonium compound antimicrobial composition will be created. Thereafter, the quaternary ammonium composition will be applied to the mop head. The quaternary ammonium composition may be applied to the mop head in any manner known in the art. For example, the mop head can be dipped in the quaternary ammonium composition as is the case with a mop head placed in a mop bucket containing quaternary ammonium composition. Alternatively, the mop head may be pre-soaked with quaternary ammonium composition. For example, in the ProGuard System from Ecolab Inc. (St. Paul, Minn.), several mop heads may be pre-soaked with quaternary ammonium composition. When an operator needs to disinfect a floor, he or she takes one of the pre-soaked mop heads and uses it for a period of time. When the pre-soaked mop head is spent, the operator removes the spent mop head and replaces it with another pre-soaked mop head. Thus, an operator can clean several rooms or an entire floor using fresh pre-soaked mop heads and never have to use a mop bucket.

In some aspects, the concentration of the quaternary ammonium compound has to be increased in order to account for absorption or adsorption onto the mop head. Accordingly, in some aspects, the method of the present invention comprises applying an amount of quaternary ammonium compound composition to a mop head, where the quaternary ammonium compound is present at an amount greater than necessary to disinfect a surface, e.g., a floor, against Pseudomonas aeuroginosa according to the AOAC Use Dilution test method. In some embodiments, about 1.5 times, about 2 times, or about 3 times the amount of quaternary ammonium composition needed to pass the AOAC Use Dilution Test against P. aeuroginosa will be applied to the mop head. It is to be understood that all values and ranges between these values and ranges are meant to be encompassed by the present invention.

In some embodiments, the concentration of quaternary ammonium compound does not have to be increased to account for absorption or adsorption. Quaternary ammonium compounds have been observed to make a floor finish sticky even when the concentration is not raised, and in some cases, even when the concentration of the quaternary ammonium compound is half of the recommended level. The methods of the present invention are also useful in these situations where a normal or less than normal quaternary ammonium compound concentration increases the stickiness of the floor.

In some aspects, after the quaternary ammonium compound composition is applied to the mop head, a portion of the composition will be transferred to the floor on a repeated daily basis. In some embodiments, the composition will be transferred to the floor on a repeated daily basis for at least about one month. The composition may be transferred to the floor on a repeated daily basis for as long as is needed, e.g., for at least about one month, at least about two months, etc. The composition may also be transferred to the floors multiple times within a single day, e.g., twice a day, three times a day.

In some aspects, the amount of quaternary ammonium composition transferred to the floor is preferably enough to pass the AOAC Use Dilution test against P. aeuruginosa on the floor. In some embodiments, this is accomplished by increasing the quaternary ammonium composition applied to the mop head, or by any other art known method, e.g., use of non-quaternary ammonium depleting textiles.

One of skill in the art will recognize that one of the many advantages of the present invention is that a quaternary ammonium composition can be applied to the floor without substantially degrading the floor finish, i.e., making the floor finish soft or sticky compared to a floor finish that has not had a quaternary ammonium composition applied to it. Softness or stickiness can be measured using a variety of test methods known to a person skilled in the art, including, but not limited to, the toner test and the glass transition temperature test called out in Examples 2, 3 and 4. When using the toner test in Example 2, the present invention preferably does not allow the ΔL value to be above 60, preferably about 50, or preferably about 40. In other words, the ΔL value for the floor finish of the present invention after a quaternary ammonium compound is applied or repeatedly applied to the floor finish will remain below 60, preferably below 50, and preferably below 40. One of skill in the art will recognize that a lower ΔL value indicates a lower degree of degradation to the floor finish.

For a more complete understanding of the invention, the following examples are given to illustrate some embodiment. These examples and experiments are to be understood as illustrative and not limiting. All parts are by weight, except where it is contrarily indicated.

### EXAMPLES

The use of the word “quat” in the following examples may represent a quaternary ammonium compound composition or it may represent the quaternary ammonium compound itself. Reference to a disinfectant implies a quat based disinfectant composition in these examples.

### Example 1

### Absorption of Quaternary Compounds by String Mops

Example 1 demonstrates that standard cotton string mops, commonly used in cleaning and disinfecting floors, absorb quat from quaternary ammonium salt based disinfectant solutions. As a result, the available quat concentration in the resulting solution that is applied to the floor is significantly reduced.

For this example, a 12 oz cotton string mop (commercially available from SSS, part no. 37305) was preconditioned by soaking in a ½ oz/gallon solution of the disinfectant A456II (commercially available from Ecolab Inc.) for one hour. After soaking, the mop was transferred to a commercial laundry machine and laundered using standard detergents and methods in order to remove any of the residual processing aids and/or oils from the cotton strings. After laundering, the mop was dried and the entire process was repeated three times.

Two gallons of a ½ oz/gallon solution of A456II was prepared by diluting the disinfectant concentrate in tap water. A 10 mL aliquot of the solution was removed and titrated for active quat using the Ecolab Test Kit #417. The titration procedure involved adding 5 drops of a 0.012% bromophenol blue and 0.0127% methyl orange indicator solution to the quat solution and then titrating with a 1.5% solution of dodecyl sodium sulfate. The endpoint of the titration occurred when the solution turned from green to gray. The ppm active quat was determined by multiplying the drops of titrant necessary to reach the endpoint by 50. The starting point quat concentration of the A456II disinfectant solution was 850 ppm and is reported as the time 0 value in Table 1.

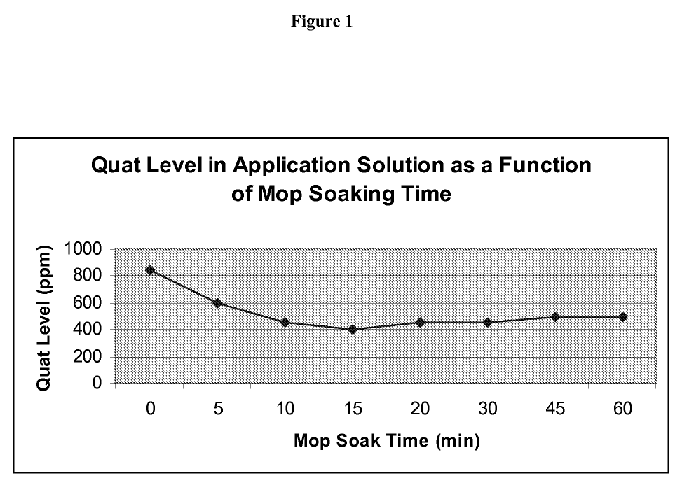

A preconditioned cotton string mop was immersed in the above disinfectant solution and allowed to remain in the solution for 5 minutes without agitation. After 5 minutes, the mop was removed from the solution and wrung out using a standard mop wringer. The mop was wrung out to a point of saturation that would typically be used to mop a floor. The excess solution was returned to the original container. The mop was transferred to a secondary beaker where approximately 20 to 30 mL of solution was hand wrung from the mop. 10 mL of this solution was transferred to a clean vial and titrated according to the procedure outlined above. Meanwhile, the mop and any excess solution were returned to the original bucket to further equilibrate. This process was repeated after 10, 15, 20, 30, 45, and 60 minutes of soaking. The values are reported in Table 1 and FIG. 1 shows the quat concentration as a function of mop soak time.

TABLE 1

| Mop Soak | Quat Level |
|---|---|
| Time (min) | (ppm) |
| 0 | 850 |
| 5 | 600 |
| 10 | 450 |
| 15 | 400 |
| 20 | 450 |
| 30 | 450 |
| 45 | 500 |
| 60 | 500 |

Table 1 and FIG. 1 clearly show that quat absorption by the mop is occurring. After only 5 minutes of soaking, the active quat level has decreased almost 30%. After another 10 minutes, the quat level is less than 50% of the original value. If the minimum amount of quat that must be delivered to a surface to be bactericidal is 850 ppm, the current situation is undesirable. In order to compensate for quat absorption by the mop, either the disinfectant concentration must be increased or the mop must be made non-absorptive.

### Example 2

### Impact of Quaternary Ammonium Based Disinfectants on Dried Floor Finish Coatings

In order to understand the impact of quaternary ammonium based disinfectants on dried floor finish coatings, the percent solids, zinc content, and disinfectant resistance of a series of commercially available floor finishes were determined. The finishes and their associated manufacturers are listed in Table 2.

Percent solids values for commercial products not identified by the manufacturer were determined using a Model HB43 halogen moisture analyzer, (available from Mettler-Toledo International, Inc.) and a 105° C. drying temperature, with the measurement being halted once the mean weight change fell below 0.1 mg/s. The percent solids refer to the percent nonvolatiles and is reported for all floor finish solutions in Table 2.

Zinc content was determined using inductively coupled plasma (ICP) analysis carried out as follows. Approximately 1.0 g of the floor finish solution was weighed in a 100 mL beaker and dried in a muffle furnace at 200° C. until no liquid was left. The sample was then ashed at 600° C. overnight, cooled, dissolved in 20 mL nitric acid and heated on a hotplate until approximately 3 mL of analyte remained in the beaker. The analyte was filtered through a glass fiber filter, diluted to volume with nanopure water in a 50 mL volumetric flask and analyzed for elemental zinc using an Optima 5300 DV simultaneous ICP instrument (Perkin Elmer). The parts per million (ppm) zinc of each of the floor finish solutions is reported in Table 2.

The disinfectant resistance of the dried floor finish coatings was determined by making coatings and exposing them to disinfectant solutions. Coatings were made using new, white vinyl composition tiles (from Congoleum Corporation, SE11). New tile surfaces were cleaned and roughened until no longer shiny by rubbing with MAGICSCRUB™ mild abrasive cleaner (available from Ecolab Inc.) using a non-woven SCOTCH-BRITE™ green abrasive scrub pad (available from 3M Company). The cleaned tiles were rinsed with tap water and dried at room temperature. This removed all factory applied coatings and surface soil and provided a consistently reproducible surface.

Coatings were applied to the scrubbed tiles at a wet coating rate of about 2000 ft²/gallon with a 1″×2″ piece of a microfiber mop. Each coat of finish was allowed to dry for 30 to 45 minutes prior to recoating. For the 21 to 25% solids floor finishes, a total of 4 coats were applied. For the 20% solids floor finishes, a total of 5 coats were applied. After coating, the finishes were allowed to dry for at least 4 hours at ambient conditions and then were placed in a 50° C. oven to age for at least 12 hours.

After aging, disinfectant resistance tests were performed on each coating. Disinfectant resistance was evaluated by affixing an adhesive-backed foam ring to the coating surface. The inner portion of each ring was filled with 10 drops of a tap water diluted composition of one of the commercial disinfectants A456II (as used in Example 1) or A456N (commercially available from Ecolab Inc.). The dilution rate for each disinfectant was 4.0 oz per gallon (1:32 by weight). The disinfectant solution was allowed to contact the coating surface for at least 12 hours. After the contact period, the ring was peeled off the surface and the disinfectant treated area was rinsed under deionized water and patted lightly with a dry cloth. The spot was allowed to dry for 30 minutes. The resulting spot was evaluated for tackiness by lightly brushing black toner obtained from a used laser printer ink cartridge (TN310K, commercially available form Konica Minolta) over the surface with a foam brush. A clean microfiber cloth was used to wipe away excess toner. The toner adhered to those areas of the coating which had degraded, i.e., were softer and stickier. The amount of toner remaining was quantitated using a Spectro-Guide 45/0 from BYK Gardner. L values for the samples were measured on a scale of 0 to 100, with 0 representing black and 100 representing white. The average L value (n=5) for all disinfectant treated areas is reported in Table 2. The average L value (n=5) of the untreated coating surface is also reported. Finally, a ΔL value is reported which is the difference in L values of the untreated and disinfectant treated areas.

TABLE 2

| | | % | L, | L, | ΔL, | L, | ΔL, |
|---|---|---|---|---|---|---|---|
| Finish | Zn (ppm) | Solids | untreated | A456II | A456II | A456N | A456N |
| Tuklar Medical¹ | 1905 | 24 | 85.77 | 29.70 | 56.07 | 60.79 | 24.98 |
| Laser¹ | 4190 | 20 | 85.7 | 16.59 | 69.11 | 67.89 | 17.81 |
| Ecolab Zinc Free Floor | 67.1 | 20 | 85.83 | 30.14 | 55.69 | 84.90 | 0.93 |
| Finish¹ | | | | | | | |
| Taj Mahal¹ | 2870 | 19 | 85.76 | 27.13 | 58.63 | 67.71 | 18.05 |
| Courtmaster II¹ | 0 | 25 | 85.68 | 83.71 | 1.97 | 85.74 | −0.06 |
| First Base¹ | 8 | 20 | 86.18 | 82.66 | 3.52 | 85.89 | 0.29 |
| IsiClean¹ | 0 | 20 | 85.91 | 52.57 | 33.34 | 84.46 | 1.45 |
| Floorstar Premium 25¹ | 6220 | 25 | 85.77 | 16.83 | 68.94 | 37.35 | 48.42 |
| Envirostar² | 5.8 | 20 | 85.51 | 25.84 | 59.67 | 76.68 | 8.83 |
| ES80 High Gloss³ | 6070 | 20 | 85.69 | 18.69 | 67.00 | 35.90 | 49.79 |
| Aquaria⁴ | 6.3 | 20 | 85.82 | 47.07 | 38.75 | 82.78 | 3.04 |
| Signature⁴ | 3050 | 20 | 85.92 | 45.49 | 40.43 | 69.38 | 16.54 |
| High Mileage⁴ | 3440 | 25 | 85.91 | 56.25 | 29.66 | 72.94 | 12.97 |
| Vectra⁴ | 6030 | 20 | 85.62 | 16.49 | 69.13 | 52.05 | 33.57 |
| Amplify⁴ | 6350 | 25 | 85.75 | 17.21 | 68.54 | 37.2 | 48.55 |
| Spartan Green | 36.6 | 20 | 85.68 | 24.66 | 61.02 | 69.13 | 16.55 |
| Solutions⁵ | | | | | | | |
| Castleguard⁶ | 2090 | 25 | 85.97 | 24.43 | 61.54 | 73.31 | 12.66 |
| MF1-2⁷ | 0 | 20 | 85.83 | 28.55 | 57.28 | 51.27 | 34.56 |

¹Commercially available from Ecolab Inc.
²Commercially available from Pioneer Eclipse Corporation.
³Commercially available from Enviro-Solutions Limited.
⁴Commercially available from Johnson Wax Professional.
⁵Commercially available from Spartan Chemical Co.
⁶Commercially available from Buckeye International.
⁷Formulated with the polymer Duragreen ™ MF1 according to the Rohm & Haas starter formulation MF-1-2.

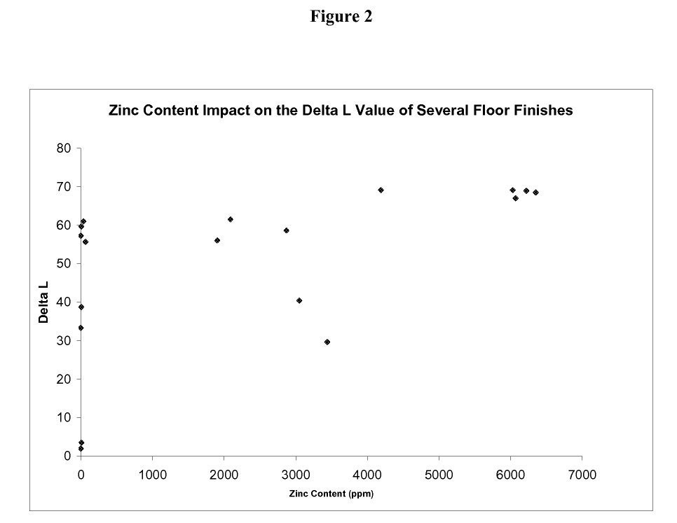

FIG. 2 graphically depicts the ΔL value for the A456II treated films versus the zinc content of the floor finish.

FIG. 2 illustrates the potential correlation between zinc content and quat resistance for the different finishes. In general, the more zinc a finish contains, the higher the ΔL value, signifying that the finish is more susceptible to attack by a quat. In standard acrylic floor finishes, zinc is added to crosslink carboxyl groups along the polymer backbones. Therefore, the finishes with high amounts of zinc must be formulated with acrylic polymers and resins containing a higher number of available carboxyl groups for crosslinking. Without wishing to be bound by any particular theory, it is thought that the presence of more free acid groups in the floor finish may cause the floor finish to be more susceptible to quat disinfectant attack. However, those finishes which do not contain zinc as the primary crosslinking mechanism have a varied composition. The acid numbers of polymers used to formulate these types of finishes varies widely and, thus, their relative quat resistance properties vary widely as can be seen on the left hand side of the above described plot.

### Example 3

### Glass Transition Temperatures of Dried Floor Finish Compositions Exposed to a Disinfectant Solution

The floor finish coatings described in Example 2 were evaluated by differential scanning calorimetry (DSC) to determine the onset of the glass transition temperature (Tg onset) for each dried coating film after exposure to one of the disinfectant solutions. Free films of each finish listed in Table 2 were cast by adding about 3.1 g of a 25% solids floor finish solution or about 3.9 g of a 20% solids floor finish solution into a 1.25 inch×5.125 inch slot with TEFLON tape laminated on the bottom surface. The finish solution in the slot was allowed to dry at ambient conditions for about 15 hours and then transferred to a 50° C. oven for an additional 5-6 hours of drying. Once drying was complete, the films were removed from the oven and cooled to ambient temperature. The resulting films were carefully peeled away from the Teflon tape, resulting in a free film which was allowed to continue to dry at ambient temperature for an additional two days.

Two small sections of each film were cut from the original free film. One piece of film was placed in a 1:32 solution of the disinfectant A456N and the other was placed in a 1:32 solution of A456II. The films were allowed to sit in the solutions overnight, after which they were removed from the solution, rinsed with tap water, and allowed to dry at ambient conditions for about 7 days.

DSC measurement was carried out on the disinfectant treated films by loading a small section of each treated film into an aluminum, non-hermetic sample DSC pan which was then sealed. The loaded sample mass ranged from 4.9 mg to 9.0 mg. A empty new pan was sealed and used as the reference for the DSC scan. The samples were run on a Q100 DSC (TA Instruments), beginning at −90° C. and ramping to 250° C., at a heating rate of 10° C./min. The onset of the glass transition temperature (Tg onset) for each film was determined by analyzing the DSC curve using the TA Universal Analysis Software. Table 3 shows the Tg onset values for the floor finishes listed in Table 2.

TABLE 3

Tg Onset (° C.)

| Finish | A456II | A456N |
|---|---|---|
| Tuklar Medical | −54 | −43 |
| Laser | −55 | −30 |
| Ecolab Zinc Free Floor | −51 | 5 |
| Finish | | |
| Taj Mahal | −48 | −8 |
| Courtmaster II | 39 | 16 |
| First Base | 33 | 31 |
| IsiClean | 42 | 43 |
| Floorstar Premium 25 | −51 | −42 |
| Envirostar | −37 | −8 |
| ES80 High Gloss | −48 | −51 |
| Aquaria | −54 | 7 |
| Signature | −51 | 22 |
| High Mileage | −45 | 18 |
| Vectra | −52 | −28 |
| Amplify | −48 | −23 |
| Spartan Green Solutions | −43 | −25 |
| Castleguard | −58 | 17 |
| MF1-2 | −62 | −50 |

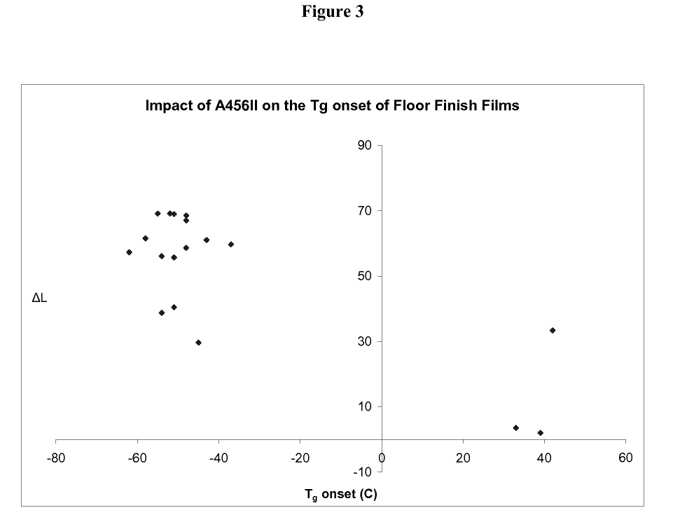

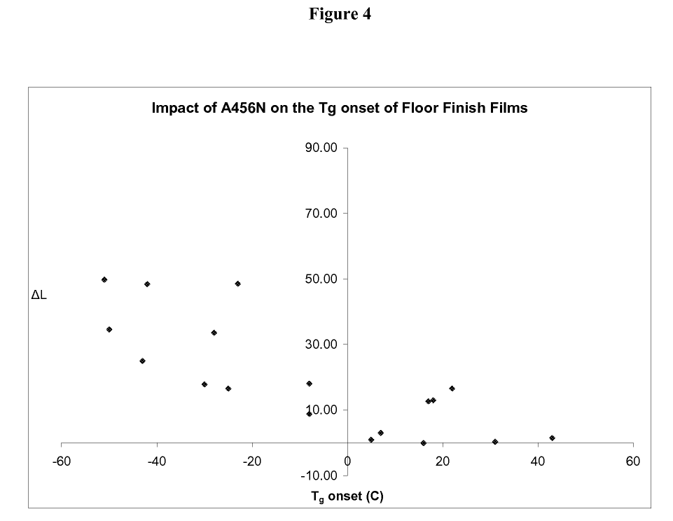

Referring to the ΔL values from Table 2, it is clear that those films that exhibit high ΔL values also have a lower onset of the glass transition temperature as listed in Table 3. Those finishes which exhibit good quat resistance and low ΔL values tend to show a higher Tg onset. These relationships are graphically shown in FIGS. 3 and 4.

This example illustrates that those finishes which exhibit poor quat resistance, also show a reduced onset of the coating glass transition temperature (Tg onset) when exposed to the disinfectant solutions used in the previous example.

### Example 4

### Thermogravimetric analysis (TGA) of Dried Floor Finish Compositions Exposed to Disinfectant Solutions

It is generally thought for floor finishes with poor quat resistance, certain components of the disinfectant solution absorb into the film, disrupting the polymer order, and lowering the glass transition temperature of the coating as shown in the previous example. In order to get a quantitative understanding of how much of these components are absorbed by the different floor finish films listed in Table 2, thermogravimetric analysis (TGA) on the films exposed to the two disinfectant solutions was performed. TGA analyses of the films soaked in water were also run as a control. The preparation of the free films and soaking procedures was as described in Example 3.

TGA was performed on a Q500 TGA (TA Instruments). The analyses were performed by loading sections of the treated films ranging in mass from 3 mg to 10 mg into platinum pans. A standard ramp test mode of heating from ambient temperature to 550° C. at a 15° C./min rate was employed.

In addition to the treated films, TGA analyses on the A456II and A456N disinfectant solutions themselves were performed in order to determine the decomposition temperatures of those materials. Each solution was dried on a watch glass at ambient temperature for several days. The dried solutions were then loaded into platinum pans and the TGA scans acquired. Evaluation of the scan profiles indicated that the majority of the dried disinfectant (>75%) decomposed below 300° C.

For the scans of the treated floor finish films, it was assumed that all weight loss on the TGA scan before 300 to 350° C. was due to the decomposition of any absorbed disinfectant solution. The percentage weight loss values for each film were determined by integrating the TGA curves below the disinfectant decomposition temperature using the TA Universal Analysis software.

Table 4 lists the percentage weight loss as determined by TGA of films soaked in water compared to those soaked in the diluted disinfectant solutions. The exact temperature below which each curve was integrated to determine weight loss percentage is listed in Table 4 for reference. A delta weight loss percentage was calculated for each disinfectant solution by subtracting the water weight loss percentage from the disinfectant weight loss percentage.

TABLE 4

| | | | | | ΔWeight % Loss | |
|---|---|---|---|---|---|---|
| | | Weight % Loss (TGA) | | | (TGA) | |
| Finish | Temp (C.)¹ | Water | A456II | A456N | A456II | A456N |
| Tuklar Medical | 304 | 10.97 | 27.55 | 27.23 | 16.58 | 16.26 |
| Laser | 300 | 12.62 | 37.15 | 30.11 | 24.53 | 17.49 |
| Ecolab Zinc | 300 | 16.82 | 25.94 | 25.51 | 9.12 | 8.69 |
| Free Floor Finish | | | | | | |
| Taj Mahal | 312 | 15.61 | 36.42 | 27.37 | 20.81 | 11.76 |
| Courtmaster II | 250 | 6.47 | 8.05 | 9.55 | 1.58 | 3.08 |
| First Base | 312 | 21.51 | 18.76 | 19.49 | −2.75 | −2.02 |
| IsiClean | 300 | 8.99 | 17.14 | 20.57 | 8.15 | 11.58 |
| Floorstar | 324, 333, | 13.27 | 38.65 | 29.03 | 25.38 | 15.76 |
| Premium 25 | 343 | | | | | |
| Envirostar | 312 | 13.09 | 28.28 | 29.37 | 15.19 | 16.28 |
| ES80 High Gloss | 300 | 10.85 | 29.11 | 29.11 | 18.26 | 18.26 |
| Aquaria | 329 | 31.17 | 35.80 | 28.90 | 4.63 | −2.27 |
| Signature | 337, 337, | 26.47 | 36.46 | 29.00 | 9.99 | 2.53 |
| | 341 | | | | | |
| High Mileage | 333, 315, | 25.16 | 35.89 | 26.91 | 10.73 | 1.75 |
| | 307 | | | | | |
| Vectra | 333 | 15.24 | 43.81 | 30.68 | 28.57 | 15.44 |
| Amplify | 300 | 17.54 | 36.68 | 27.23 | 19.14 | 9.69 |
| Spartan Green Solutions | 309 | 15.36 | 35.52 | 27.59 | 20.16 | 12.23 |
| Castleguard | 335-336 | 11.78 | 36.23 | 25.68 | 24.45 | 13.90 |
| MF1-2 | 289 | 9.00 | 32.94 | 31.82 | 23.94 | 22.82 |

¹Temperature below which TGA curve was integrated.

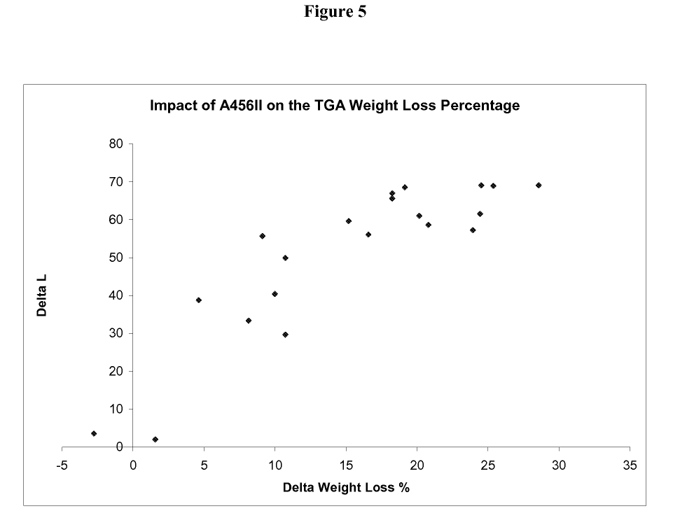

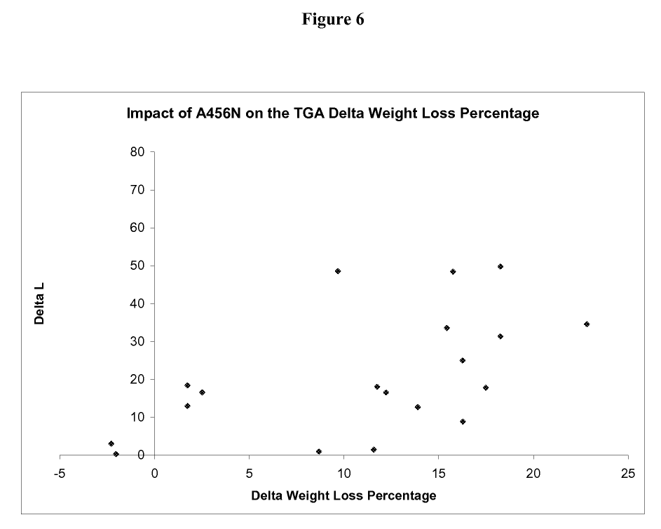

The values in Table 4 indicate that those finishes whose weight loss percentage is greater after exposure to a quat disinfectant solution, exhibit reduced quat resistance as indicated by high ΔL values associated with those finishes (Table 2). This is graphically represented in FIGS. 5 and 6 which illustrate the ΔL as a function of the delta weight loss percentage for the A456II and A456N soaked films. The general trends indicate that the greater the delta weight loss percentage, the higher the ΔL value.

### Example 5

### Resistance of Dried Floor Finish Compositions to Antimicrobial Solutions

Not only is it advantageous for a finish to exhibit excellent quat resistance, but a resistance to alcohol based sanitizers is also preferred. This example illustrates the dual properties of quat and alcohol resistance for a series of floor finish formulations shown in Table 5. All formulation amounts are listed in terms of weight percentage.

TABLE 5

| Ingredient | 1 | 2 | 3 | 4 | 5 | 6 |
|---|---|---|---|---|---|---|
| Water | 57.5 | 55.5 | 55.5 | 58.9 | 55.5 | 55.5 |
| Preservative¹ | 0.03 | 0.03 | 0.03 | 0.03 | 0.03 | 0.03 |
| Wetting surfactant² | 0.03 | 0.03 | 0.03 | 0.03 | 0.03 | 0.03 |
| Defoamer³ | 0.05 | 0.05 | 0.05 | 0.05 | 0.05 | 0.05 |
| Coalescent⁴ | 4.7 | 4.7 | 4.7 | 4.7 | 47 | 4.7 |
| Plasticizer⁵ | 1.5 | 1.5 | 1.5 | 1.5 | 1.5 | 1.5 |
| Polymer A⁶ | 38.2 | | | | | |
| Polymer B⁷ | | 40.2 | | | | |
| Polymer C⁸ | | | 40.2 | | | |
| Polymer D⁹ | | | | 36.8 | | |
| Polymer E¹⁰ | | | | | 40.2 | |
| Polymer F¹¹ | | | | | | 40.2 |

¹Kathon CG/ICP, 1.5% solids Rohm & Haas
²Zonyl FSJ, 40% solids, Dupont.
³SE-21, Wacker Silicones Corp.
⁴Ditheylene glycol ethyl ether, Eastman.
⁵Tributoxyl ethyl phosphate (KP-140), Rhodia.
⁶Duragreen MF-1, 40% solids, Rohm & Haas.
⁷DP3, 38% solids, Rohm & Haas
⁸UHS, 38% solids, Rohm & Haas.
⁹Rhoplex 2133, 41.5% solids, Rohm & Haas.
¹⁰Rhoplex 2923, 38% solids, Rohm & Haas
¹¹Rhoplex 2624, 38% solids, Rohm & Haas.

Coatings of the finishes listed in Table 5 were prepared according to the procedure described in Example 2. In addition to coating a white tile, a black tile (Congoleum Corporation, SE22) was also coated with each of the formulations. In all cases, a total of coats were applied to each tile. The tiles were aged in a 50° C. oven for at least 24 hours and then allowed to sit at ambient temperature until the tests were conducted.

The quat resistance of each finish was determined according to the method described in Example 2. In this example, 0.5 g of a 1:32 solution of A45611 and a 1:32 solution of A456N was dropped into the wells of foam rubber rings affixed to each of the coating surfaces. The disinfectant solutions were allowed to contact the coating surfaces for 24 hours. After contact, the ring was removed from the coating surface; the treated area was rinsed, allowed to dry for 30 minutes and then toned with black toner as previously described in Example 2. After toning, the color density of each spot was measured as described previously. Table 6 lists the average L value (n=5) for each finish. In addition the average L value of an untreated area of coating is also reported. The ΔL values reported in Table 6 were calculated as described in Example 2.

The alcohol resistance of each coating was evaluated using the coated black tiles. To each coating surface, a single drop of the alcohol hand disinfectant ENDURE 300 (commercially available from Ecolab) was applied. The drop was allowed to sit on the coating surface for 60 minutes after which a wet cloth was used to wipe away any remaining material. The treated area was allowed to dry for 15 minutes and the color was measured using the BYK spectroguide instrument described in Example 2. A white index value (WI) was recorded and is reported in Table 6. In addition to a color measurement, each treated area was inspected and visual observations about the coating removal were recorded. The last column in Table 6 records the visual observations.

TABLE 6

| | L, | L, | ΔL, | L, | ΔL, | White | Coating |
|---|---|---|---|---|---|---|---|
| Formulation | Untreated | A456II | A456II | A456N | A456N | Index | Removed |
| 6-1 | 84.48 | 51.35 | 33.13 | 69.09 | 15.39 | 13.82 | No |
| 6-2 | 85.72 | 22.57 | 63.15 | 42.98 | 42.74 | 37.13 | No |
| 6-3 | 85.78 | 32.74 | 53.04 | 48.02 | 37.76 | 35.94 | No |
| 6-4 | 85.68 | 40.14 | 45.54 | 79.31 | 6.37 | 70.87 | No |
| 6-5 | 86 | 86.67 | −0.67 | 85.31 | 0.69 | 92.31 | No |
| 6-6 | 85.79 | 52.13 | 33.66 | 81.17 | 4.62 | NA | Yes |

The lower the white index value, the less white the coating turned upon exposure to alcohol or the better its alcohol resistance. Table 6 shows that some coatings not only exhibit good quat resistance (low delta L values) but also good alcohol resistance (low white index). An example of such a coating is Formulation 6-1 which is based on the Duragreen MF-1 polymer from Rohm & Haas.

### Example 6

### Impact of Quaternary Ammonium Based Disinfectants on Dried Floor Finish Compositions

To further explore alternative classes of floor coatings that provide improved disinfectant resistance, an experiment similar to that described in Example 2 was performed on dried aziridine crosslinked conventional floor coatings as well as dried polyol-isocyanate crosslinked polyurethane coatings. The conventional floor finishes used herein were, for example, zinc crosslinked acrylic floor coatings. Without wishing to be bound by any particular theory, it is thought that the additional crosslinking mechanisms present in these coatings will increase their disinfectant resistance.

The conventional floor coating MARKETSTAR™ (25% solids, Ecolab Inc) was crosslinked with aziridine by mixing an amount equal to 1.5% by weight of aziridine into the finish for 1 minute and then allowing the mixture to rest for 15 minutes prior to coating. The resulting composition was applied to a white vinyl composition tile at a coating rate of 2000 ft²/gal. A total of five coats of the composition with a dry time of approximately 30 to 45 minutes between coats was applied. A control tile coated with 5 coats of MARKETSTAR™ was also included.

The polyol-isocyanate crosslinked polyurethane finishes evaluated were the commercially available three part system GLOSSTEK GT100™ (45% solids, from Ecolab Inc) and the two part system LQW47-100DM™ (22% solids, from Henkel). A single coat of GLOSSTEK GT100™ was applied to a white vinyl composition tile at a coating rate of 400 ft2/gal using a 1″×2″ piece of PadBRUSH wand (applicator)(Padco Inc.) with adhesive backed PadBRUSH sheet (pad, cut to about 1″×1.5″)(Padco Inc.) affixed to the applicator. Using the same coating procedure as a conventional finish, five coats of LQW47-100DM™ with a dry time of approximately 30 to 45 minutes between coats were applied to white vinyl composition tile.

All coatings were allowed to cure for at least four months at ambient temperature. A variation of the test method described in Example 2 was used to test the disinfectant resistance of the dried floor coatings. The starting or untreated color (L value) of the dried finishes was measured with the BYK Spectroguide and can be found in Table 7. Four adhesive-backed foam rings were applied to each coating surface and filled with 10 drops of a 4 oz/gal tap water diluted composition of A456II. The disinfectant solution was allowed to contact the coating surfaces overnight. After the contact period, the rings were peeled away from the coatings and the treated areas rinsed under deionized water. The rinsed areas were then allowed to dry for 30 minutes after which they were toned with the black toner as described previously. In this example, two operators (denoted Operator 1 and Operator 2) performed the toning such that each operator toned two disinfectant exposed areas on each coating. This was done to account for any operator to operator variability in the toning process. After toner application, the toner was wiped away with a piece of ¼″ roll cotton (Padco, Cat. No. 79210006) by Operator 1 and a paper towel by Operator 2. The resulting L value of the toned spots was measured. Only a single color measurement is reported for each spot. The average L value of the two spots after toning was calculated for each operator and the ΔL value was calculated by subtracting the average A456II treated and toned L value from the untreated L value as is shown in Table 7.

TABLE 7

| | | | L (spot 1), | L (spot 2), | Average | ΔL, |
|---|---|---|---|---|---|---|
| Finish | Operator | L, untreated | A456II | A456II | L, A456II | A456II |
| MarketStar | 1 | 85.10 | 72.78 | 68.94 | 70.86 | 14.24 |
| MarketStar + | 1 | 84.92 | 78.90 | 79.37 | 79.14 | 5.79 |
| 1.5% | | | | | | |
| aziridine | | | | | | |
| LQW47- | 1 | 84.99 | 84.27 | 84.29 | 84.28 | 0.71 |
| 100DM | | | | | | |
| GlossTek | 1 | 84.84 | 84.74 | 84.77 | 84.76 | 0.09 |
| GT100 | | | | | | |
| MarketStar | 2 | 85.10 | 76.61 | 73.91 | 75.26 | 9.84 |
| MarketStar + | 2 | 85.03 | 77.56 | 75.79 | 76.68 | 8.35 |
| 1.5% | | | | | | |
| aziridine | | | | | | |
| LQW47- | 2 | 85.01 | 82.24 | 83.25 | 82.75 | 2.27 |
| 100DM | | | | | | |
| GlossTek | 2 | 84.81 | 84.31 | 83.77 | 84.04 | 0.77 |
| GT100 | | | | | | |

Some of the disinfectant treated spots on the MARKETSTAR™ finish did not tone uniformly. These spots appeared much darker around the perimeter than in the center. In all cases, the color measured by the BYK spectroguide was at the center of the spots. It is expected that if measured at the perimeter, the L value would be much lower, leading to a greater ΔL. Nevertheless, Table 7 illustrates that the MARKETSTAR™ finish has the highest ΔL value in comparison to the other finishes that were evaluated. This indicates that it is more susceptible to disinfectant attack, i.e., degradation, and thus picks up more of the toner. The GLOSSTEK GT100™ has the lowest ΔL value indicating that it is the most disinfectant resistant. The aziridine crosslinked and LQW47-100DM™ finishes are intermediate in terms of disinfectant resistance.

Even taking into account the nonuniformity of toning in this example, the ΔL values of the conventional finish (e.g. MARKETSTAR) after treatment with disinfectant and toner are much less than conventional finishes in the previous examples (Examples 2 and 5). Without wishing to be bound by any particular theory, it is thought that the discrepancy in the ΔL values may be due to differences in toner age, coating age, curing conditions, or environmental conditions during the toning process. Nevertheless, the trends are still apparent in this example; the more crosslinked a finish, the more resistant to disinfectant attack.

### Example 7

### Dried Floor Finish Compositions Resistance to Exposure to a Disinfectant Solution

Expanding on the previous example, the following test was performed to directly assess the level of tackiness or stickiness that results when the disinfectant solution contacts the coatings. The conventional coatings tested included MARKETSTAR™, LASER™, TUKLAR MEDICAL™, and FLOORSTAR PREMIUM 25™. The cross linked coatings include aziridine crosslinked versions of the conventional coatings, as well as LQW47-100DM™ and GLOSSTEK GT1100™. All coatings were coated on black VCT as described previously.

After one month aging at ambient temperature, the coatings were exposed to a 1:32 dilution of A456II using the adhesive backed foam ring method described previously. One exception to the procedure previously described is that the rings were filled to the top with disinfectant solutions (as opposed to only adding 10 drops). After a contact time of 2 hours, the remaining disinfectant solution was removed from the ring, the ring was removed from the surface, and the area was gently blotted dry. After allowing the spot to dry for 30 minutes, the tackiness was assessed by placing a small square of ¼″ roll cotton (Padco, Cat. No. 79210006) on the exposed spot and placing a 2 kg calibration weight on top of the cotton. The weight was allowed to sit on the cotton for 20 seconds and then removed. The cotton square was then gently pulled up and the amount of cotton adhering to the coating surface was evaluated. A visual rating scale of 0 to 3 was used to describe the level of cotton adherence. A rating of ‘0’ indicated that no cotton was stuck to the surface while a rating of ‘3’ indicated that a large amount of cotton remained on the surface. Table 8 lists the results.

TABLE 8

| Coating | 1 & 2 hour test Mar. 28, 2007 |
|---|---|
| MarketStar | 3 |
| MarketStar + 1.5% aziridine | 0 |
| MarketStar + 2.5% aziridine | 0 |
| Premium 25 | 3 |
| Premium 25 + 1.5% aziridine | 0.5 |
| Premium 25 + 2.5% aziridine | 0.5 |
| Laser | 3 |
| Laser + 1.2% aziridine | 0.5 |
| Laser + 2.0% aziridine | 0 |
| Tuklar Medical | 3 |
| Tuklar Medical + 2.5% aziridine | 0 |
| LQW47-100DM | 0 |
| GlossTek GT100 | 0 |

Table 8 illustrates that the aziridine crosslinked coatings as well as the polyol-isocyanate polyurethane coatings are more resistant to disinfectant attack, resulting in less tackiness of the surface and less cotton adherence to the surface.

### Example 8

### Dried Floor Finish Compositions Resistance to Repeated Exposure to a Disinfectant Solution

In order to more accurately represent what would occur in the field with multiple disinfectant applications to a floor coating, the following disinfectant resistance experiment was performed on the MARKETSTAR™, GLOSSTEK GT100™, and LQW47-100DM™ floor coatings already described. This experiment involved the use of a soil drum apparatus adapted from the carpet industry for testing the soil resistance of carpets. The apparatus consists of a 12.5″ diameter tube that is 13″ long. The tube is enclosed by removable endcaps on both ends. To the interior of the tube or drum, 2″×10.5″ sections of finish coated vinyl composition tile are taped. The tile sections are oriented such that their length is parallel to the drum rotation axis and they are spaced evenly around the perimeter of the drum. The finish coated sides of the tiles are faced toward the interior of the drum. Soiled pellets are introduced into the drum, the drum ends are fastened, and the entire apparatus is rotated about its long axis by placing the drum on two 4″ rotating cylinders, placed approximately 8″ apart. The soiled pellets are prepared by mixing 2 g of AATC-TM-122 Synthetic Carpet Soil (from Textile Innovators Corporation) sieved through a 75 micrometer screen with 1000 g of Zytel polymer pellets (Cat. No. 6801, Serial # 1021588).

White vinyl composition tiles were prepared and coated with five coats of MARKETSTAR™ and LQW47-100DM™ and a single coat of GLOSSTEK GT1100 as described previously. All coatings were allowed to cure for at least 2 weeks at ambient temperature. After curing, the tiles were cut into 2″10.5″ sections. Two tile sections from each tile were used for testing.

One of the tile sections for each coating was left untreated and the L value was measured using the BYK Gardner Spectroguide. These values can be found in the “No Disinfectant Treatment” section of Table 9 under the column heading “Before.” Once the color was measured, the three tile sections were placed in the soiling drum as described previously.

The other tile section for each coating type was treated with disinfectant. In the center of each tile section, 250 uL of a 1.2 oz/gal solution of A456II in tap water was applied. Immediately after application, a 2″×2″ square of 8 ply gauze (Kendall Curity) was used to distribute the disinfectant evenly across the coating surface. The disinfectant solution was allowed to dry for 30 minutes and the entire process was repeated. After a total of six applications of disinfectant were applied, the tiles were allowed to dry for 30 minutes and then the L color data was collected with the BYK Gardner SpectroGuide. The data is listed in the “Disinfectant Treatment” section of Table 9 under the column heading “Before.” The disinfectant tiles were then inserted into the soil drum which already contained the three untreated tiles.

The six tiles were spaced evenly around the interior of the drum. To the drum, 100 g of soiled pellets were added and the end was replaced. The pellets were manually distributed across the length of the drum and the entire assembly was placed on the rotating cylinders. The drum was rotated at a speed setting of ‘60’ (approximately 16 rpm) for a total of 60 minutes.

After 60 minutes of rotation, the tile sections were removed from the drum. A visual inspection of the tile sections was performed. For the MARKETSTAR™ tile section that had been treated with disinfectant, there was a dark circular spot in the middle of the tile strip, approximately ¾″ in diameter, which was noticeably darker than the surrounding areas. The location of the dark spot corresponds to where the disinfectant solution was originally dosed before being spread out over the entire surface with the gauze pad. The surrounding tile area was much lighter in color, however it was visually darker than the MARKETSTAR™ tile that wasn't treated with disinfectant but had also been soiled in the drum. For the case of the LQW47-100DM™ and GLOSSTEK GT-100™ coated tiles, there was not a visually apparent drop spot in the center of the tile sections treated with disinfectant and soiled. Visually, the color of the soiled treated areas appeared slightly darker than the soiled untreated tiles. Color readings were taken on the soiled tiles obtained from the drum and are under the respective column headings beginning with “After” in Table 9. In addition, a ΔL value was calculated by subtracting the After color value from the Before color value for each condition.

TABLE 9

| | No Disinfectant | | | | | | |
|---|---|---|---|---|---|---|---|
| | Treatment | | | Disinfectant Treatment | | | |
| | | After | | | After Soil L-- | | |
| | | Soil | | | Drop | After Soil L - | |
| Finish | Before L | L | ΔL | Before L | Spot | Surrounding | ΔL |
| MarketStar | 84.76 | 81.18 | 3.58 | 84.88 | 72.33 | 79.96 | 12.55/4.92 |
| GlossTek | 84.75 | 82.72 | 2.03 | 84.83 | none | 82.7 | 2.13 |
| GT-100 | | | | | | | |
| LQW47- | 84.63 | 82.31 | 2.32 | 84.57 | none | 81.43 | 3.14 |
| 100DM | | | | | | | |

The presence of a dark spot in the middle of the MARKETSTAR tile is reflected in Table 9 by the L value of 72.33. This is the lowest L value, indicating it is the most soiled area of the tile. Without wishing to be bound by any particular theory, it is thought that this area is the result of very high initial concentration of quat that was dosed onto the surface. The high concentration attacked the conventional acrylic finish, leading to a sticky or tacky area that picked up significant soil. After dosing and mopping up the solution with the gauze pad, it is expected that the concentration of quat in the disinfectant solution decreases due to absorption by the gauze pad and potentially the finish itself. For this reason, the surrounding areas of the MARKETSTAR™ tile are not as heavily attacked and soiled. However, the ΔL value of the surrounding area of the treated MARKETSTAR™ tile is greater than the untreated MARKETSTAR™ tile indicating that there is still some attack of the disinfectant.

The LQW47-100DM™ and GLOSSTEK GT100™ floor coatings did not exhibit a dark drop spot and the overall ΔL value for the treated tile sections is only slightly greater than the untreated tile sections. These finishes are more highly crosslinked and most likely more resistant to disinfectant attack. The results in Table 9 indicate that GLOSSTEK GT110™ is the most resistant floor coating to disinfectant attack followed by the LQW47-100DM™ coating. This is consistent with the results from Examples 6 and 7.

### Example 9

### Dried Floor Finish Compositions Resistance to Repeated Exposure to a Disinfectant Solution

A similar experiment described in Example 8 was also performed on an aziridine crosslinked conventional finish. A white vinyl composition tile was coated with a 1.5% (w/w) aziridine in MARKETSTAR™ composition as described in Example 6. A control tile coated with 5 coats of MARKETSTAR™ and another tile coated with 5 coats of LQW47-100DM was also included in the study. In all cases, the coatings were allowed to cure for at least 4 months at ambient temperature.

The disinfectant resistance tests were performed as described in Example 8 with the following exception. Instead of using a new gauze pad to distribute the disinfectant solution across the tile surface, a gauze pad that had been presaturated in the disinfectant solution was used. In this way, it is expected that the presaturated gauze pad would not absorb any additional quat and the quat concentration in the dosed solution would remain relatively constant. Again, a total of six disinfectant applications, spaced at 30 minute intervals, were applied to each tile. After the final disinfectant application, the tiles were allowed to dry for 30 minutes and the color was recorded. The tiles were then placed into the soiling drum. After 60 minutes of operation, the tile sections were removed and the resulting color was measured and is recorded in Table 10.

TABLE 10

| | No Disinfectant | | | | | | |
|---|---|---|---|---|---|---|---|
| | Treatment | | | Disinfectant Treatment | | | |
| | | After | | | After Soil L-- | After Soil L- | |
| Finish | Before L | Soil L | ΔL | Before L | Drop Spot | Surrounding | ΔL |
| MarketStar | 84.83 | 82.98 | 1.85 | 85.05 | 76.55 | 78.18 | 8.5/6.87 |
| MarketStar + | 84.70 | 83.44 | 1.26 | 84.62 | None | 82.74 | 1.88 |
| 1.5% | | | | | | | |
| aziridine | | | | | | | |
| LQW47- | 84.90 | 83.27 | 1.63 | 84.52 | none | 82.71 | 1.81 |
| 100DM | | | | | | | |

The ΔL for the disinfectant treated MARKETSTAR™ is significantly greater than the ΔL value for the untreated tile. This indicates that the soil resistance of the MARKETSTAR™ has been significantly compromised by the disinfectant. As in the previous example, there is also a drop spot present in the center of the MARKETSTAR™ tile. However the contrast between the drop spot and the surrounding area is much less for this MARKETSTAR™ sample because the surrounding area is much darker. It is thought that in the previous example, much of the quat was actually absorbed by the new or fresh gauze pad. This resulted in a lower overall quat concentration being distributed onto the outer area of the tile. Therefore, the disinfectant attack and resulting soiling was observed to be lower. In the current example, the quat concentration remains high due to presaturation of the gauze pad. Therefore, the contrast between the drop spot and surrounding area is not as great because the surrounding areas are exposed to a higher level of quat.

The tile samples coated with the crosslinked MARKETSTAR™ and the LQW finishes have much lower ΔL values after soiling than the conventional MARKETSTAR coated tile, indicating that they are more resistant to the disinfectant treatment. Again, these tiles do not exhibit any type of drop spot near the center.

### Example 10

### Dried Floor Finish Compositions Resistance to Exposure to Alcohol Based Compositions

It is preferable for a floor coating to be both disinfectant and alcohol resistant. The sensitivity to attack by alcohol of the dried coatings in Example 7 was evaluated. The experiment was designed to mimic what may happen in the field when a finish is exposed to an alcohol containing product for a period of time before it is removed from the floor. It is assumed that the exposure time period is short enough that some of the alcohol containing product remains in the wet state on the finish. Removing the wet product from the surface can sometimes result in permanent damage to the coating. The alternative scenario, in which the alcohol containing product is allowed to fully dry on the surface before removal is illustrated in Example 11.

All coatings were coated on black VCT as described previously. After curing for at least 20 days at ambient temperature, the coatings were exposed to the alcohol hand sanitizer gel, ENDURE 300™ (Ecolab Inc). A quarter size drop of the gel was placed on each finish surface and allowed to contact it for one hour before a wet paper towel was used to gently remove the gel from the surface. The damage or impact on the coating in terms of gloss loss, whitening, visible residue, and blisters was determined. Table 11 details the various evaluation criteria used to assess coating damage. In the case of gloss loss, a Micro-TRI-Gloss Meter (available from BYK Gardner) was used to measure the 60° gloss. For the other criteria, a visual rating scale of 0 to 3 was utilized in which 0 corresponded to no impact and 3 corresponded to a significant impact on the coating.

TABLE 11

| Observation | Description |
|---|---|
| % 60° Gloss Loss | (((Original Gloss) − (Gloss of area exposed to |
| | alcohol))/(Original Gloss)) * 100 |
| Whitening | Spot exposed to alcohol gel turned white in color |
| Residue gel retained | Dried alcohol gel retained on the surface; difficult |
| | to wipe away even with wet paper towels |
| Small blister | Small (pin hole size) blisters are formed in the area |
| | exposed to alcohol gel |
| Visible gel drop | Area exposed to alcohol gel is visibly different than |
| | surrounding area |
| Total defect rating | Sum of whitening, residue gel retained, small |
| | blister, and visible gel drop defect ratings |

The gloss loss as well as impact ratings can be found in Table 12.

TABLE 12

| | | Alcohol | % | | Residue | | Visible | |
|---|---|---|---|---|---|---|---|---|
| | Original | 60° | gloss | | Gel | Small | Gel | Total |
| Finish | 60° gloss | gloss | loss | Whitening | Retained | Blister | Drop | Defect |
| MarketStar | 72.1 | 29.3 | 59.4% | 3 | 2 | 0 | 3 | 8 |
| MarketStar + | 86.6 | 74.4 | 14.1% | 0 | 0 | 1 | 1 | 2 |
| 1.5% aziridine | | | | | | | | |
| MarketStar + | 84.8 | 69.6 | 17.9% | 0 | 0 | 1 | 1 | 2 |
| 2.5% aziridine | | | | | | | | |
| Premium 25 | 68.7 | 48.9 | 28.8% | 1 | 2 | 0 | 3 | 6 |
| Premium 25 + | 82.3 | 68.1 | 17.3% | 0 | 0 | 1 | 1 | 2 |
| 1.5% aziridine | | | | | | | | |
| Premium 25 + | 79.5 | 70.5 | 11.3% | 0 | 0 | 1 | 1 | 2 |
| 2.5% aziridine | | | | | | | | |
| Laser | 63.5 | 47.2 | 25.7% | 1 | 2 | 0 | 3 | 6 |
| Laser + 1.2% | 82.7 | 71.4 | 13.7% | 0 | 0 | 1 | 1 | 2 |
| aziridine | | | | | | | | |
| Laser + 2.0% | 76.7 | 71.5 | 6.8% | 0 | 0 | 0.5 | 0.5 | 1 |
| aziridine | | | | | | | | |
| Tuklar Medical | 76.2 | 19.5 | 74.4% | 2 | 1 | 0 | 3 | 6 |
| Tuklar Medical + | 84.3 | 73.8 | 12.5% | 0.5 | 0 | 1 | 1.5 | 3 |
| 2.5% | | | | | | | | |
| aziridine | | | | | | | | |
| LQW47-100DM | 85.3 | 76.3 | 10.6% | 0 | 0 | 0.5 | 0.5 | 1 |
| GlossTek | 87.3 | 86.0 | 1.5% | 0 | 0 | 0 | 0 | 0 |
| GT100 | | | | | | | | |

The percent gloss loss for the aziridine crosslinked versions of the conventional finishes is lower than that for the non-aziridine cross linked versions of the conventional finishes, indicating that they are more resistant to alcohol attack. The total defect rating of the aziridine crosslinked coatings is also lower. The polyol-isocyanate polyurethane coatings are more resistant to alcohol attack than conventional finishes as is illustrated in the low percent gloss loss and defect rating values.

### Example 11

### Dried Floor Finish Compositions Resistance to Prolonged Exposure to Alcohol Based Compositions

It is possible that in use a dried floor coating may be exposed to an alcohol containing product that is allowed to completely dry on the surface before removal. In order to simulate this scenario, the following experiment was completed. Black vinyl composite tiles were coated with MARKETSTAR™, MARKETSTAR™ with 1.5% by weight aziridine, TUKLAR MEDICAL™ with 2.5% by weight aziridine, and LQW47-100DM™ as described previously. All coatings were allowed to age at ambient temperature for at least 20 days after which they were exposed to ENDURE 300™ (described previously), ENDURE 450™ (Ecolab Inc), and ENDURE 320™ (Ecolab Inc.). The alcohol gels were applied to the coating surface as described in Example 10. However, instead of removing the gels after 60 minutes of contact time, the gels were allowed to dry completely on the coating surface. After 14 days, the dried gels were removed from the coating surface by first dry wiping with a paper towel and then wet wiping. The wet wiping process involved applying water to the dried gel spot until the gel was swollen. After swelling, a wet paper towel was used to gently remove the gel and the spot was allowed to dry. In addition to a percentage gloss loss, the coatings were visually evaluated as described in the previous example. The results can be seen in Tables 13 and 14. The additional criteria of “swelling” was also recorded. In this case, a coating was given a rating of 1 if the addition of water to the dried gel swelled it sufficiently in less than 5 minutes and the gel could be completely removed by wiping. A rating of 2 indicates that sufficient swelling occurred in 5-10 minutes. A rating of 3 indicates that after 30 minutes, the gel was not sufficiently swollen or removed with wiping.

TABLE 13

| | | Endure 300 | | Endure 450 | | Endure 320 | |
|---|---|---|---|---|---|---|---|
| | Original | Alcohol | % Gloss | Alcohol | % Gloss | Alcohol | % Gloss |
| Finish | 60° gloss | 60° gloss | Loss | 60° gloss | Loss | 60° gloss | Loss |
| MarketStar | 76.4 | 10.0 | 86.9% | 22.4 | 70.7% | 9.8 | 87.2% |
| MarketStar + | 83.6 | 66.6 | 20.3% | 79.0 | 5.5% | 75.2 | 10.0% |
| 1.5% aziridine | | | | | | | |
| Tuklar Medical + | 78.2 | 74.6 | 4.6% | 70.0 | 10.5% | 73.2 | 6.4% |
| 2.5% aziridine | | | | | | | |
| LQW47-100DM | 83.3 | 78.0 | 6.4% | 82.3 | 1.2% | 79.2 | 4.9% |

TABLE 14

| | | | Residue | | | Visible | |
|---|---|---|---|---|---|---|---|
| Alcohol | | | gel | Small | | gel drop | Total |
| gel | Finish | Whitening | retained | blister | Swelling | mark | defect |
| Endure | MarketStar | 2 | 2 | 0 | 0 | 3 | 7 |
| 300 | MarketStar + 1.5% | 0 | 0 | 1.5 | 0 | 1 | 2.5 |
| | aziridine | | | | | | |
| | Tuklar Medical + | 0.5 | 0 | 1 | 0 | 1.5 | 3 |
| | 2.5% aziridine | | | | | | |
| | LQW47-100DM | 0 | 0 | 1 | 0 | 1 | 2 |
| Endure | MarketStar | 0 | 3 | 0 | 3 | 3 | 9 |
| 450 | MarketStar + 1.5% | 0 | 0 | 0 | 2 | 1 | 3 |
| | aziridine | | | | | | |
| | Tuklar Medical + | 0 | 0 | 0 | 0 | 0.5 | 0.5 |
| | 2.5% aziridine | | | | | | |
| | LQW47-100DM | 0 | 0 | 0 | 2 | 1 | 3 |
| Endure | MarketStar | 0 | 1 | 0 | 0 | 3 | 4 |
| 320 | MarketStar + 1.5% | 0 | 0 | 2 | 0 | 1.5 | 3.5 |
| | aziridine | | | | | | |
| | Tuklar Medical + | 0 | 0 | 2 | 0 | 1.5 | 3.5 |
| | 2.5% aziridine | | | | | | |
| | LQW47-100DM | 0 | 0 | 2 | 0 | 1.5 | 3.5 |

As can be seen from the above tables, the crosslinked finishes have improved dried alcohol gel resistance over the conventional finish control, MARKETSTAR™.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

In addition, the contents of all patent publications discussed supra are incorporated in their entirety by this reference.

What is claimed is:

1. A method of treating floors comprising:
a) applying an antimicrobial resistant floor finish composition comprising a polyol-isocyanate crosslinkable polyurethane floor finish composition to a floor;
b) applying a quaternary ammonium compound antimicrobial composition to a mop head, wherein the quaternary ammonium compound is present in an amount greater than necessary to disinfect Pseudomonas aeruginosa according to the AOAC Use Dilution test method; and
c) transferring the quaternary ammonium compound composition from the mop head to the floor on a repeated daily basis, wherein at least enough quaternary ammonium compound needed to disinfect Pseudomonas aeruginosa according to the AOAC Use Dilution test method is transferred to the floor without substantially degrading the floor finish.

2. The method of claim 1, wherein the floor finish is resistant to quaternary ammonium compound.

3. The method of claim 1, wherein the floor finish is resistant to Glucoprotamin-based compositions.

4. The method of claim 1, wherein the floor finish is resistant to alcohol-based compositions.

5. The method of claim 2, wherein the floor finish is further resistant to alcohol-based compositions.

6. The method of claim 3, wherein the floor finish is further resistant to alcohol-based compositions.

7. The method of claim 1, wherein the floor finish composition comprises a single floor finish.

8. The method of claim 1, wherein the floor finish composition comprises multiple floor finishes.

9. The method of claim 1, wherein the step of applying the floor finish composition comprises applying a single layer of a floor finish composition.

10. The method of claim 1, wherein the step of applying the floor finish composition comprises applying multiple layers of a floor finish composition.

11. The method of claim 10, wherein the floor finish composition applied in each layer is the same.

12. The method of claim 10, wherein the floor finish composition applied in at least one layer is different than the floor finish composition applied in another layer.

13. The method of claim 12, wherein at least the top most layer comprises the antimicrobial resistant floor finish composition.

14. The method of claim 1, wherein the amount of quaternary ammonium compound applied to the mop head is at least about 1.5 times the amount necessary to disinfect Pseudomonas aeruginosa according to the AOAC Use Dilution test method.

15. The method of claim 1, wherein the amount of quaternary ammonium compound applied to the mop head is at least about two times the amount necessary to disinfect Pseudomonas aeruginosa according to the AOAC Use Dilution test method.

16. The method of claim 1, wherein the mop head is a flat mop made of microfiber.

17. The method of claim 1, wherein the floor is located in a patient care location.

18. The method of claim 17, wherein the patient care location is a hospital, nursing home, surgical center, veterinary facility, dentist office, eye care office, clinic, long term care facility, or daycare.

19. A method of treating floors comprising:
a) applying an antimicrobial resistant floor finish composition comprising a floor finish cross linked with aziridine to a floor;
b) applying a quaternary ammonium compound antimicrobial composition to a mop head, wherein the quaternary ammonium compound is present in an amount greater than necessary to disinfect Pseudomonas aeruginosa according to the AOAC Use Dilution test method; and
c) transferring the quaternary ammonium compound composition from the mop head to the floor on a repeated daily basis, wherein at least enough quaternary ammonium compound needed to disinfect Pseudomonas aeruginosa according to the AOAC Use Dilution test method is transferred to the floor without substantially degrading the floor finish.

20. The method of claim 19, wherein the floor finish is selected from the group consisting of an acrylic floor finish, a zinc cross linked acrylic floor finish and mixtures thereof.

21. The method of claim 20, wherein the floor finish is resistant to an antimicrobial selected from the group consisting of a quaternary ammonium compound, Glucoprotamin-based compositions, alcohol-based compositions, and mixtures thereof.

22. The method of claim 19, wherein the amount of quaternary ammonium compound applied to the mop head is at least about 1.5 times the amount necessary to disinfect Pseudomonas aeruginosa according to the AOAC Use Dilution test method.

23. A method of treating floors comprising:
a) applying an antimicrobial resistant floor finish composition comprising a zinc free acrylic floor finish to a floor;
b) applying a quaternary ammonium compound antimicrobial composition to a mop head, wherein the quaternary ammonium compound is present in an amount greater than necessary to disinfect Pseudomonas aeruginosa according to the AOAC Use Dilution test method; and
c) transferring the quaternary ammonium compound composition from the mop head to the floor on a repeated daily basis, wherein at least enough quaternary ammonium compound needed to disinfect Pseudomonas aeruginosa according to the AOAC Use Dilution test method is transferred to the floor without substantially degrading the floor finish.

24. The method of claim 23, wherein the floor finish is resistant to an antimicrobial selected from the group consisting of a quaternary ammonium compound, Glucoprotamin-based compositions, alcohol-based compositions, and mixtures thereof.

25. The method of claim 23, wherein the amount of quaternary ammonium compound applied to the mop head is at least about 1.5 times the amount necessary to disinfect Pseudomonas aeruginosa according to the AOAC Use Dilution test method.
